(19) United States
(12) Patent Application Publication
(10) Pub. No.: US 2008/0105024 A1
(43) Pub. Date: May 8, 2008

(54) Method of making an auto-calibrating test sensor

(75) Inventors: John P. Creaven, Granger, IN (US); Andrew J. Dosmann, Granger, IN (US); Allen J. Brenneman, Goshen, IN (US); Steven C. Charlton, Osceola, IN (US)

Correspondence Address: NIXON PEABODY LLP, 161 N. CLARK STREET, 48TH FLOOR, CHICAGO, IL, 60601, US

(73) Assignee: Bayer HealthCare LLC

(21) Appl. No.: 11/982,819

(22) Filed: Nov. 5, 2007

Related U.S. Application Data
(60) Provisional application No. 60/857,370, filed on Nov. 7, 2006.
(60) Provisional application No. 60/925,227, filed on Apr. 18, 2007.

(51) Int. Cl. G01N 21/00; G01N 27/00

(52) U.S. Cl. 73/1.02; 29/593

(57) ABSTRACT

A test sensor is made that is adapted to assist in determining the concentration of an analyte in a fluid sample. The method includes providing a lid and providing a base. The lid is attached to the base to form an attached lid-base structure. The lid-base structure has a first end adapted to receive the fluid sample and a second opposing end adapted to be placed into a meter. Auto-calibration information is assigned to the lid-base structure. The second opposing end is formed such that the shape of the second opposing end corresponds to the auto-calibration information.

### CROSS-REFERENCE TO RELATED APPLICATIONS

This application claims priority to U.S. Provisional Application Ser. Nos. 60/857,370 filed on Nov. 7, 2006 and 60/925,227 filed Apr. 18, 2007, which are incorporated by reference in their entirety.

### FIELD OF THE INVENTION

The present invention generally relates to a method of making a test sensor that is adapted to determine an analyte concentration. More specifically, the present invention generally relates to a method of making an auto-calibrating test sensor.

### BACKGROUND OF THE INVENTION

The quantitative determination of analytes in body fluids is of great importance in the diagnoses and maintenance of certain physiological abnormalities. For example, lactate, cholesterol and bilirubin should be monitored in certain individuals. In particular, it is important that diabetic individuals frequently check the glucose level in their body fluids to regulate the glucose intake in their diets. The results of such tests can be used to determine what, if any, insulin or other medication needs to be administered. In one type of blood-glucose testing system, test sensors are used to test a sample of blood.

A test sensor contains biosensing or reagent material that reacts with, for example, blood glucose. The testing end of the sensor is adapted to be placed into the fluid being tested, for example, blood that has accumulated on a person's finger after the finger has been pricked. The fluid may be drawn into a capillary channel that extends in the sensor from the testing end to the reagent material by capillary action so that a sufficient amount of fluid to be tested is drawn into the sensor. The tests are typically performed using optical or electrochemical testing methods.

Diagnostic systems, such as blood-glucose testing systems, typically calculate the actual glucose value based on a measured output and the known reactivity of the reagent-sensing element (test sensor) used to perform the test. The reactivity or lot-calibration information of the test-sensor may be provided on a calibration circuit that is associated with the sensor package or the test sensor. This calibration circuit is typically physically inserted by the end user. In other cases, the calibration is automatically done using an auto-calibration circuit via a label on the sensor package or the test sensor. In this case, calibration is transparent to the end user and does not require that the end user insert a calibration circuit into the meter. Manufacturing millions of sensor packages, each having a calibration circuit or label to assist in calibrating the sensor package, can be expensive.

Therefore, it would be desirable to have a test sensor that provides auto-calibration information thereon that can be manufactured in an efficient and/or cost-effective manner.

### SUMMARY OF THE INVENTION

According to one method, a test sensor is made that is adapted to assist in determining the concentration of an analyte in a fluid sample. The method comprises providing a lid and providing a base. The lid is attached to the base to form an attached lid-base structure. The lid-base structure has a first end adapted to receive the fluid sample and a second opposing end adapted to be placed into a meter. Auto-calibration information is assigned to the lid-base structure. The second opposing end is formed such that the shape of the second opposing end corresponds to the auto-calibration information.

According to another method, a test sensor and a meter are adapted to use auto-calibration information in determining the concentration of an analyte in a fluid sample. The method comprises providing a test sensor including a lid portion and a base portion. The lid and the base portions form a lid-base structure. The lid-base structure has a first end adapted to receive the fluid sample and a second opposing end adapted to be placed into a meter. Auto-calibration information is assigned to the lid-base structure. The second opposing end is formed such that the shape of the second opposing end corresponds to the auto-calibration information. A meter is provided with a test-sensor opening. The second opposing end of the test sensor is placed into the test-sensor opening of the meter. The shape of the second opposing end is detected. The auto-calibration information is determined from the shape of the second opposing end and applied in determining the analyte concentration.

According to another method, a test sensor is made that is adapted to assist in determining the concentration of an analyte in a fluid sample. The method comprises providing a lid and providing a base. The lid is attached to the base to form an attached lid-base structure. The lid-base structure has a first end adapted to receive the fluid sample and a second opposing end adapted to be placed into a meter. Auto-calibration information is assigned to the lid-base structure. At least one cutout is formed near or at the second opposing end such that the shape, dimensions and/or number of the at least one cutout corresponds to the program auto-calibration number.

According to another method, a test sensor and a meter are adapted to use auto-calibration information in determining the concentration of an analyte in a fluid sample. The method comprises providing a test sensor including a lid portion and a base portion. The lid and the base portions form a lid-base structure. The lid-base structure has a first end adapted to receive the fluid sample and a second opposing end adapted to be placed into a meter. Auto-calibration information is assigned to the lid-base structure. At least one cutout is formed near or at the second opposing end such that the shape, dimensions and/or number of the at least one cutout corresponds to the program auto-calibration number. A meter is provided with a test-sensor opening. The second opposing end of the test sensor is placed into the test-sensor opening of the meter. The shape, dimensions and/or number of the at least one cutout of the second opposing end is detected. The auto-calibration information is determined from the shape of the cutout and applied in determining the analyte concentration.

According to a further method, a test sensor is adapted to assist in determining the concentration of an analyte in a fluid sample. The method comprises providing a lid and providing a base. The lid is attached to the base to form an attached lid-base structure. The lid-base structure has a first end adapted to receive the fluid sample and a second opposing end adapted to be placed into a meter. Auto-calibration information is assigned to the lid-base structure. At least one partial cutout is formed near or at the second opposing end such that the shape, dimensions and/or number of the at least one partial cutout corresponds to the program auto-calibration number.

According to a further method, a test sensor and a meter are adapted to apply auto-calibration information in determining the concentration of an analyte in a fluid sample. The method comprises providing a test sensor including a lid portion and a base portion. The lid and the base portions form a lid-base structure. The lid-base structure has a first end adapted to receive the fluid sample and a second opposing end adapted to be placed into a meter. Auto-calibration information is assigned to the lid-base structure. At least one partial cutout is formed near or at the second opposing end such that the shape, dimensions and/or number of the at least one partial cutout corresponds to the program auto-calibration number. A meter is provided with a test-sensor opening. The second opposing end of the test sensor is placed into the test-sensor opening of the meter. The shape, dimensions and/or number of the at least one partial cutout of the second opposing end is detected. The auto-calibration information is determined from the shape of the partial cutout and applied in determining the analyte concentration.

According to yet another method, a test sensor is made that is adapted to assist in determining the concentration of an analyte in a fluid sample. The method comprises providing a base with a first end adapted to receive the fluid sample and a second opposing end adapted to be placed into a meter. Auto-calibration information is assigned to the base. The second opposing end of the base is formed such that the shape of the second opposing end corresponds to the auto-calibration information.

According to yet another method, a test sensor and a meter is used that is adapted to use auto-calibration information in determining the concentration of an analyte in a fluid sample. The method comprises providing a test sensor including a base with a first end adapted to receive the fluid sample and a second opposing end adapted to be placed into a meter. Auto-calibration information is assigned to the test sensor. The second opposing end is formed such that the shape of the second opposing end corresponds to the auto-calibration information. A meter is provided with a test-sensor opening. The second opposing end of the test sensor is placed into the test-sensor opening of the meter. The shape of the second opposing end is detected. The auto-calibration information is determined from the shape of the second opposing end and applied in determining the analyte concentration.

According to yet another method, a test sensor is made that is adapted to assist in determining the concentration of an analyte in a fluid sample. The method comprises providing a base with a first end adapted to receive the fluid sample and a second opposing end adapted to be placed into a meter. Auto-calibration information is assigned to the base. At least one cutout is formed near or at the second opposing end such that the shape, dimensions and/or number of the at least one cutout corresponds to the program auto-calibration number.

According to another method, a test sensor and a meter are adapted to use auto-calibration information in determining the concentration of an analyte in a fluid sample. The method comprises providing a base with a first end adapted to receive the fluid sample and a second opposing end adapted to be placed into a meter. Auto-calibration information is assigned to the test sensor. At least one cutout is formed near or at the second opposing end such that the shape, dimensions and/or number of the at least one cutout corresponds to the program auto-calibration number. A meter is provided with a test-sensor opening. The second opposing end of the test sensor is placed into the test-sensor opening of the meter. The shape, dimensions and/or number of the at least one cutout of the second opposing end is detected. The auto-calibration information is determined from the shape of the cutout and applied in determining the analyte concentration.

According to another method, a test sensor is made that is adapted to assist in determining the concentration of an analyte in a fluid sample. The method comprises providing a base with a first end adapted to receive the fluid sample and a second opposing end adapted to be placed into a meter. Auto-calibration information is assigned to the base. At least one partial cutout is formed near or at the second opposing end such that the shape, dimensions and/or number of the at least one partial cutout corresponds to the program auto-calibration number.

According to yet another method, a test sensor and a meter are adapted to apply auto-calibration information in determining the concentration of an analyte in a fluid sample. The method comprises providing a base with a first end adapted to receive the fluid sample and a second opposing end adapted to be placed into a meter. Auto-calibration information is assigned to the test sensor. At least one partial cutout is formed near or at the second opposing end such that the shape, dimensions and/or number of the at least one partial cutout corresponds to the program auto-calibration number. A meter is provided with a test-sensor opening. The second opposing end of the test sensor is placed into the test-sensor opening of the meter. The shape, dimensions and/or number of the at least one partial cutout of the second opposing end is detected. The auto-calibration information is determined from the shape of the partial cutout and applied in determining the analyte concentration.

According to one embodiment, an electrochemical test sensor is adapted to determine an analyte concentration of a fluid sample. The electrochemical test sensor comprises a base, a plurality of electrodes and at least one reagent. The base includes a first base end and an opposing second base end. The plurality of electrodes is formed on the base at or near the first end. The plurality of electrodes includes a working electrode and a counter electrode. At least one reagent is positioned at or near the first end so as to contact the fluid sample. The electrochemical test sensor includes a first end and an opposing second end. The test sensor has an auto-calibration area. The auto-calibration area has non-conductive markings in a form of a pattern corresponding to auto-calibration information. The markings are adapted to be optically detected.

According to another embodiment, an optical test sensor is adapted to determine an analyte concentration of a fluid sample. The optical test sensor comprises a base, a fluid-receiving area and at least one reagent. The base includes a first base end and an opposing second base end. The fluid-receiving area is adapted to receive a fluid sample. The fluid-receiving area is located near or at the first base end. The at least one reagent is positioned to contact the fluid sample in the fluid-receiving area. The at least one reagent assists in optically determining the analyte concentration of the fluid sample. The optical test sensor includes a first end and an opposing second end. The auto-calibration area has non-conductive markings in a form of a pattern corresponding to auto-calibration information. The markings are adapted to be optically detected.

### BRIEF DESCRIPTION OF THE DRAWINGS

FIG. 1a is a top view of a test sensor with a generally round-shaped end according to one embodiment.

FIG. 1b is a side view of the test sensor of FIG. 1a.

FIG. 2a is a top view of a test sensor with a generally rectangular-shaped end according to one embodiment.

FIG. 2b is a side view of the test sensor of FIG. 2a.

FIG. 3a is a top view of a test sensor with a generally triangular-shaped end according to one embodiment.

FIG. 3b is a side view of the test sensor of FIG. 3a.

FIG. 4a is a top view of a test sensor without a spacer with a generally circular-shaped end according to one embodiment.

FIG. 4b is a cross-sectional view taken generally along line 4b-4-b of FIG. 4a.

FIG. 5a is an isometric view of a meter according to one embodiment that is adapted to receive the test sensors of FIGS. 1-4.

FIG. 5b is an isometric view of a meter according to another embodiment that is adapted to receive a cartridge.

FIG. 6 is an optical read head according to one embodiment.

FIG. 7a is a top view of a test sensor with a generally rectangular-shaped cutout at one end according to one embodiment.

FIG. 7b is a side view of the test sensor of FIG. 7a.

FIG. 7c is a cross-sectional view of FIG. 7a taken generally along the line 7c-7c.

FIG. 8a is a top view of a test sensor with a generally circular-shaped cutout at one end according to one embodiment.

FIG. 8b is a side view of the test sensor of FIG. 8a.

FIG. 8c is a cross-sectional view of FIG. 8a taken generally along the line 8c-8c.

FIG. 9a is a top view of a test sensor with a generally triangular-shaped cutout at one end according to one embodiment.

FIG. 9b is a side view of the test sensor of FIG. 9a.

FIG. 9c is a cross-sectional view of FIG. 9a taken generally along the line 9c-9c.

FIG. 10a is a top view of a test sensor without a spacer with a generally triangular-shaped cutout according to one embodiment.

FIG. 10b is a cross-sectional view taken generally along line 10b-10b of FIG. 10a.

FIG. 11a is a top view of a test sensor with a plurality of apertures according to one embodiment.

FIG. 11b is a side view of the test sensor of FIG. 11a.

FIG. 11c is a cross-sectional view of FIG. 11a taken generally along the line 11c-11c.

FIG. 12a is a top view of a test sensor with a plurality of apertures according to another embodiment.

FIG. 12b is a side view of the test sensor of FIG. 12a.

FIG. 12c is a cross-sectional view of FIG. 12a taken generally along the line 12c-12c.

FIG. 13a is a top view of a test sensor with a plurality of apertures according to a further embodiment.

FIG. 13b is a side view of the test sensor of FIG. 13a.

FIG. 13c is a cross-sectional view of FIG. 13a taken generally along the line 13c-13c.

FIG. 14a is a top view of a test sensor without a spacer with a plurality of apertures according to one embodiment.

FIG. 14b is a cross-sectional view taken generally along line 14b-14b of FIG. 14a.

FIG. 15a is a top view of a test sensor with a generally rectangular-shaped partial cutout at one end according to one embodiment.

FIG. 15b is a side view of the test sensor of FIG. 15a.

FIG. 16a is a top view of a test sensor with a generally circular-shaped partial cut out at one end according to one embodiment.

FIG. 16b is a side view of the test sensor of FIG. 16a.

FIG. 17a is a top view of a test sensor with a generally triangular-shaped partial cutout atone end according to one embodiment.

FIG. 17b is a side view of the test sensor of FIG. 17a.

FIG. 18a is a top view of a test sensor without a spacer with a generally triangular-shaped partial cutout according to one embodiment.

FIG. 18b is a cross-sectional view taken generally along line 18b-18b of FIG. 18a.

FIG. 19a is a top view of an integrated test sensor with a generally round-shaped end according to one embodiment.

FIG. 19b is a side view of the test sensor of FIG. 19a.

FIG. 20a is a top view of an integrated test sensor with a generally rectangular-shaped cutout at one end according to one embodiment.

FIG. 20b is a side view of the test sensor of FIG. 20a.

FIG. 20c is a cross-sectional view of FIG. 7a taken generally along the line 7c-7c.

FIG. 21 is a top view of a one-layer test sensor with a generally round-shaped end according to one embodiment.

FIG. 22 is a top view of a one-layer test sensor with a generally rectangular-shaped end according to one embodiment.

FIG. 23 is a top view of a one-layer test sensor with a generally triangular-shaped end according to one embodiment.

FIG. 24 is a top view of a one-layer test sensor with a generally rectangular-shaped cutout at one end according to one embodiment.

FIG. 25 is a top view of a one-layer test sensor with a generally circular-shaped cutout at one end according to another embodiment.

FIG. 26 is a top view of a one-layer test sensor with a generally triangular-shaped cutout at one end according to one embodiment.

FIG. 27 is a top view of a one-layer test sensor with a plurality of apertures according to one embodiment.

FIG. 28 is a top view of a one-layer test sensor with a plurality of apertures according to a further embodiment.

FIG. 29 is a top view of a one-layer test sensor with a plurality of apertures according to a further embodiment.

FIG. 30 is a top view of a one-layer test sensor with a generally rectangular-shaped partial cutout at one end according to one embodiment.

FIG. 31 is a top view of a one-layer test sensor with a generally circular-shaped partial cutout at one end according to one embodiment.

FIG. 32 is a top view of a one-layer test sensor with a generally triangular-shaped partial cutout at one end according to one embodiment.

FIG. 33 is a top view of an electrochemical test sensor with a plurality of auto-calibration markings according to one embodiment.

FIG. 34 is an enlarged view of the generally square area labeled FIG. 34 in FIG. 33.

FIG. 35 is an enlarged view of an auto-calibration area according to one embodiment.

FIG. 36 is an enlarged view of an auto-calibration area according to another embodiment.

FIG. 37a is a top view of an electrochemical test sensor with a lid having a plurality of auto-calibration markings according to one embodiment.

FIG. 37b is a side view of the electrochemical test sensor of FIG. 37a.

FIG. 38 is a top view of an optical test sensor having a plurality of auto-calibration markings according to one embodiment.

FIG. 39a is a top view of an optical test sensor with lid having a plurality of auto-calibration markings according to one embodiment.

FIG. 39b is a side view of the electrochemical test sensor of FIG. 39a.

### DETAILED DESCRIPTION OF ILLUSTRATED EMBODIMENTS

Generally, an instrument or meter uses a test sensor adapted to receive a fluid sample to be analyzed, and a processor adapted to perform a predefined test sequence for measuring a predefined parameter value. A memory is coupled to the processor for storing predefined parameter data values. Calibration information associated with the test sensor may be read by the processor before the fluid sample to be measured is received. Calibration information may be read by the processor before or after the fluid sample to be measured is received, but not after the analyte concentration has been determined. Calibration information is generally used to compensate for different characteristics of test sensors, which will vary on a batch-to-batch basis. In some systems, the calibration information is provided on an auto-calibration circuit or label that is associated with each test sensor batch.

The calibration information may be, for example, the lot specific reagent calibration information for the test sensor. The calibration information may be in the form of a calibration code. Selected information associated with the test sensor (which may vary on a batch-to-batch basis) is tested to determine the calibration information to be used in association with the meter.

The present invention is directed to an improved method of making a test sensor that is adapted to assist in determining the analyte concentration. In one method, a test sensor is adapted to receive a fluid sample and is analyzed using an instrument or meter. Analytes that may be measured include glucose, lipid profiles (e.g., cholesterol, triglycerides, LDL and HDL), microalbumin, hemoglobin A_{1C}, fructose, lactate, or bilirubin. It is contemplated that other analyte concentrations may be determined. The analytes may be in, for example, a whole blood sample, a blood serum sample, a blood plasma sample, other body fluids like ISF (interstitial fluid) and urine, and non-body fluids. As used within this application, the term “concentration” refers to an analyte concentration, activity (e.g., enzymes and electrolytes), titers (e.g., antibodies), or any other measure concentration used to measure the desired analyte.

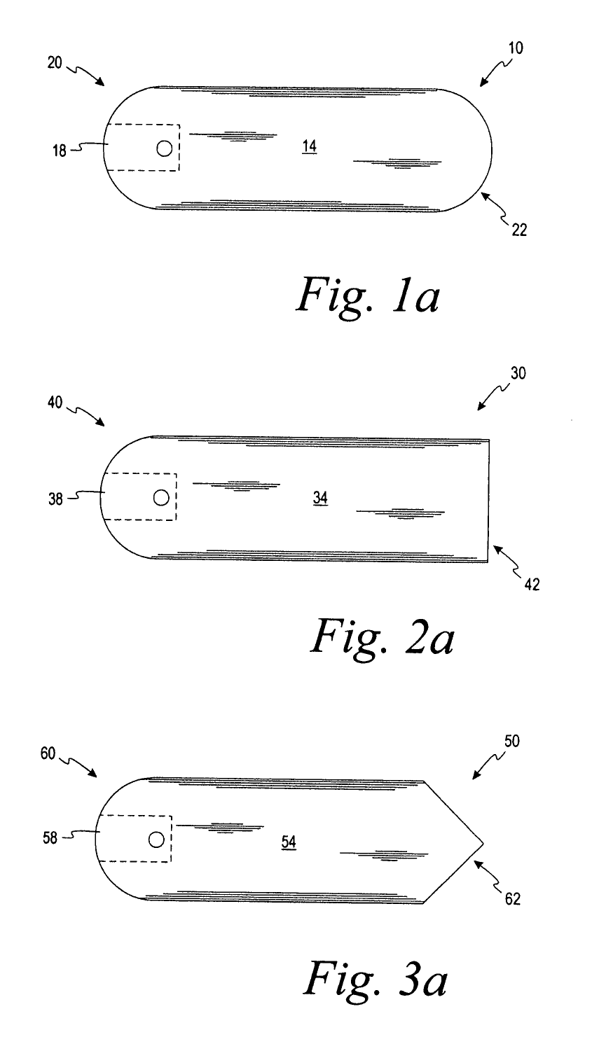

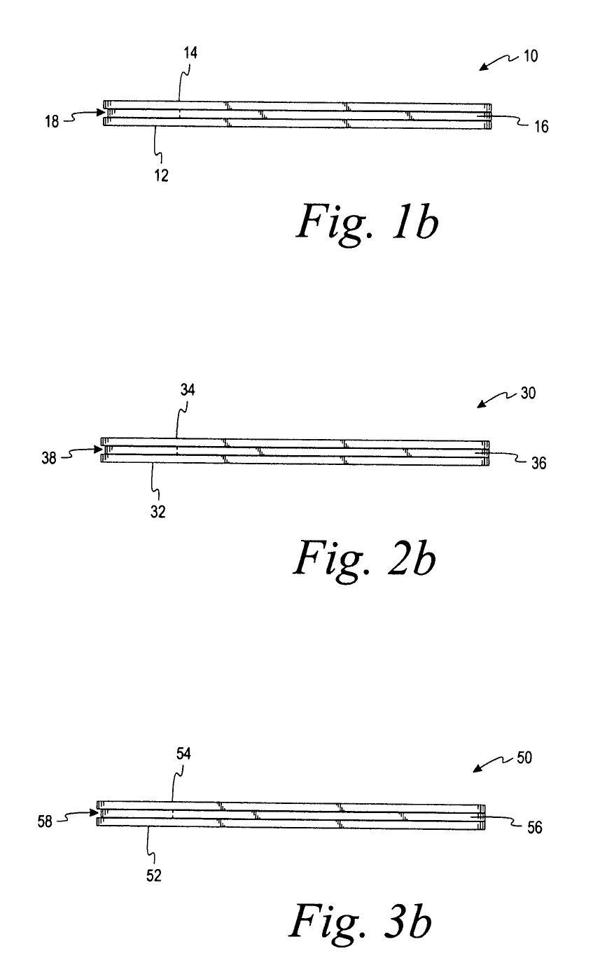

Referring to FIGS. 1-3, test sensors 10, 30 and 50 are shown. Each of the test sensors includes a base, a lid and a spacer with the spacer located between the lid and the spacer. Specifically, the test sensor 10 of FIGS. 1a, 1b includes a base 12, a lid 14 and a spacer 16. Similarly, the test sensor 30 of FIGS. 2a, 2b includes a base 32, a lid 34 and a spacer 36, while the test sensor 50 of FIGS. 3a, 3b includes a base 52, a lid 54 and a spacer 56. The base, lid and spacer may be made from a variety of materials such as polymeric materials. Non-limiting examples of polymeric materials that may be used to form the base, lid and spacer include polycarbonate, polyethylene terephthalate (PET), polyethylene naphthalate (PEN), polyimide and combinations thereof.

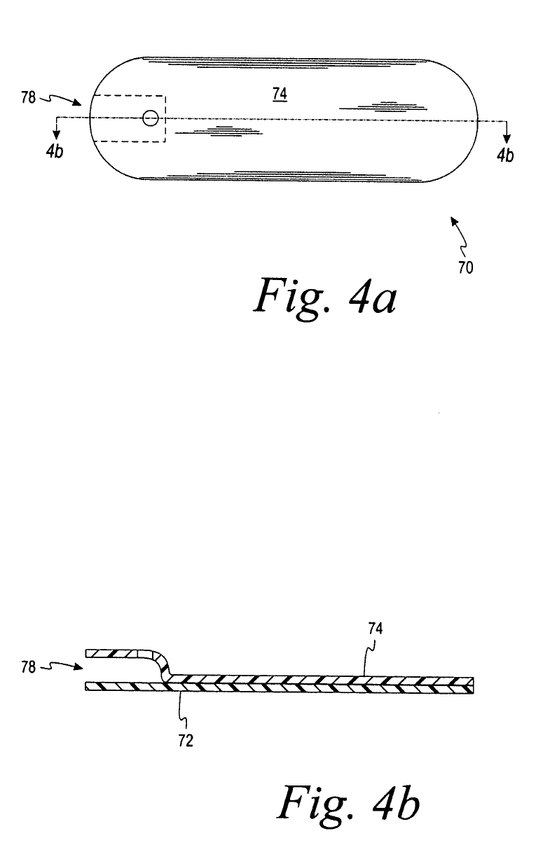

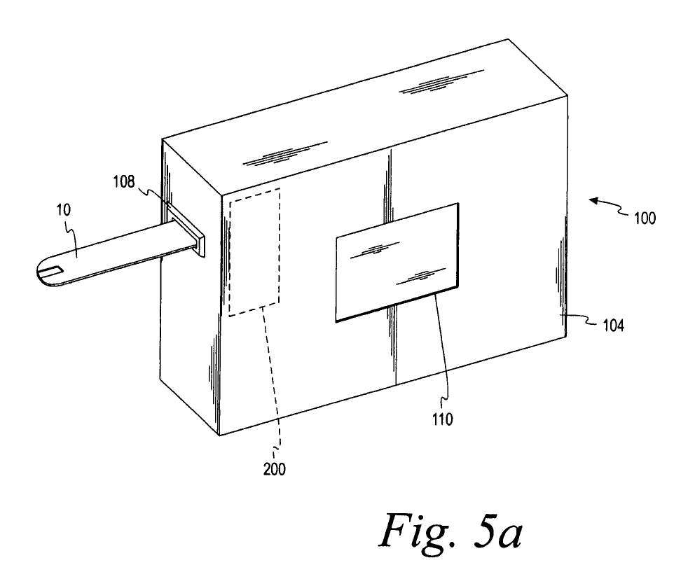

It is contemplated that the test sensors may be formed with a base and a lid in the absence of a spacer. In one such embodiment, a lid may be formed with a convex opening that is adapted to receive a fluid. A non-limiting example of such a test sensor is shown in FIGS. 4a, 4b. Specifically, in FIGS. 4a, 4b, a test sensor 70 includes a base 72 and a lid 74. When the lid 72 is attached to the base 74, a fluid-receiving area 78 is formed that is adapted to receive fluid for testing.

Referring back to FIG. 1b, when the base 12, the lid 14 and the spacer 16 are attached together, a fluid-receiving area 18 is formed. Similarly, in FIGS. 2b, 3b, respective fluid-receiving areas 38, 58 are formed when the respective base, lid and spacers are attached. The fluid-receiving areas provide a flow path for introducing the fluid sample into the test sensor. Referring back to FIGS. 1a, 1b, the fluid-receiving area 18 is formed at a first end or testing end 20 of the test sensor 10. Similarly, in FIGS. 2a, 3a, the fluid-receiving areas 38, 58 are formed at a respective first end or testing end 40, 60 of their respective test sensor 30, 50.

The test sensor may be an optical test sensor. Optical test sensor systems may use techniques such as, for example, transmission spectroscopy, diffuse reflectance or fluorescence spectroscopy for measuring the analyte concentration. An indicator reagent system and an analyte in a sample of body fluid are reacted to produce a chromatic reaction—the reaction between the reagent and analyte causes the sample to change color. The degree of color change is indicative of the analyte concentration in the body fluid. The color change of the sample is evaluated to measure the absorbance level of the transmitted light. Transmission spectroscopy is described in, for example, U.S. Pat. No. 5,866,349. Diffuse reflectance and fluorescence spectroscopy are described in, for example, U.S. Pat. Nos. 5,518,689 (entitled “Diffuse Light Reflectance Read Head”); 5,611,999 (entitled “Diffuse Light Reflectance Read Head”); and 5,194,393 (entitled “Optical Biosensor and Method of Use”).

It is also contemplated that the test sensor may be an electrochemical test sensor. In such an embodiment, the meter has optical aspects so as to determine the auto-calibration information and electrochemical aspects to determine the analyte concentration of the fluid sample. The electrochemical test sensor typically includes a plurality of electrodes and a fluid-receiving area that contains an enzyme. The enzyme is selected to react with the desired analyte or analytes to be tested so as to assist in determining an analyte concentration of a fluid sample. The fluid-receiving area includes a reagent for converting an analyte of interest (e.g., glucose) in a fluid sample (e.g., blood) into a chemical species that is electrochemically measurable, in terms of the electrical current it produces, by the components of the electrode pattern. The reagent typically contains an enzyme such as, for example, glucose oxidase, which reacts with the analyte and with an electron acceptor such as a ferricyanide salt to produce an electrochemically measurable species that can be detected by the electrodes. It is contemplated that other enzymes may be used to react with glucose such as glucose dehydrogenase. If the concentration of another analyte is to be determined, an appropriate enzyme is selected to react with the analyte.

To form the test sensor 10 of FIGS. 1a, 1b, the base 12, the spacer 16, and the lid 14 are attached by, for example, an adhesive. It is contemplated that other materials may be used that have sticking properties such that the lid, base and spacer remain attached. The base 12 may be laminated to the spacer 16 using, for example, a pressure-sensitive adhesive and/or a hot melt adhesive. Thus, the lamination between the base and the spacer uses pressure, heat or the combination thereof. It is contemplated that other materials may be used to attach the base to the spacer. Similarly, the lid 14 and the spacer 16 may be attached using the same or a different adhesive than the adhesive used between the base 12 and the spacer 16.

It is contemplated that the base and spacer may be attached by other methods such as heat sealing. Similarly, the lid and the spacer may be attached by other methods such as heat sealing. Thus, in one embodiment, the test sensor includes a base, a spacer and a lid without an adhesive layer. For example, the spacer may be made of a lower melting temperature material than the lid and the base. The heat sealing may be accomplished by, for example, sonic welding.

In another embodiment, the lid or base may be heat-sealed to the spacer with the remaining one of the lid and base being adhesively attached to the spacer. For example, the lid and spacer may be heat sealed while the base is attached to the spacer via an adhesive layer.

According to another embodiment, a spacer-lid combination is used in which the spacer and lid have been previously attached before being attached to the base. According to a further embodiment, a spacer-base combination is used in which the spacer and the base have been previously attached before being attached to the lid.

The test sensor 70 of FIGS. 4a, 4b may be formed using the methods described above such as heat-sealing or via an adhesive.

In addition to the first end or testing end of the test sensor, each of the test sensors includes a second opposing end. Referring to FIGS. 1a, 1b, the test sensor 10 includes a second opposing end 22. The second opposing end 22 is adapted to be placed into a meter or instrument. The second opposing end 22, as shown in FIG. 1a, is generally round shaped.

Similarly, the test sensor 30 of FIG. 2a includes a second opposing end 42. The second opposing end 42 is adapted to be placed into a meter or instrument. The second opposing end 42 is shown as being a generally rectangular-shaped end. The test sensor 50 of FIG. 3a includes a second opposing end 62. The second opposing end 62 is adapted to be placed into a meter or instrument. The second opposing end 62 is shown as being a generally triangular-shaped end.

The shapes of the second opposing ends 22, 42 and 62 are formed to correspond with the auto-calibration information of the test sensor. The shape of the second opposing end is varied in production such that a certain test-sensor end shape corresponds to specific calibration information (e.g., a certain program number or code). Specifically, calibration information is determined and assigned for a particular test sensor. The calibration information for the test sensors 10, 30 and 50 was determined to be different. Because the calibration information was different, the shapes of the second opposing ends were formed of different shapes. Thus, after the calibration information is assigned to a particular test sensor, the shape of the opposing end of the test sensor is formed to correspond with the auto-calibration information. The auto-calibration information is used by a meter or instrument to determine how to calibrate the test sensor. Specifically, the meter detects the different shapes of the test sensors and uses, for example, the appropriate program number from the meter software.

The auto-calibration information may be any information that can be used by a meter or instrument to auto-calibrate. For example, the auto-calibration information may be a program auto-calibration number that relates to a slope and intercept of calibration lines for the test sensor lot or batch.

The forming of a particular shape of the second opposing end of a test sensor may be done by several methods. For example, the desired shape of the second opposing end may be formed by cutting. The cutting may be done, by, for example, a laser. In another method, the desired shape of the second opposing end may be formed by a punching operation such as using a punching tool.

In addition to the various end shapes of the test sensors shown in FIGS. 1-4, it is contemplated that the second opposing ends of the test sensors may have other polygonal and non-polygonal shapes. It is also contemplated that the different calibration information may have smaller differences in the second opposing ends. For example, the second opposing ends may have minor differences in shape and/or dimensions that represent different auto-calibration information.

Similarly, different shaped opposing ends may be used with a test sensor that includes a base and a lid in the absence of a spacer (e.g., test sensor 70 of FIG. 4a with a generally round-shaped end). For example, an opposing end may have a generally rectangular shape or a triangular shape such as shown in FIGS. 2a and 3a. It is contemplated that other polygonal and non-polygonal shapes may be used.

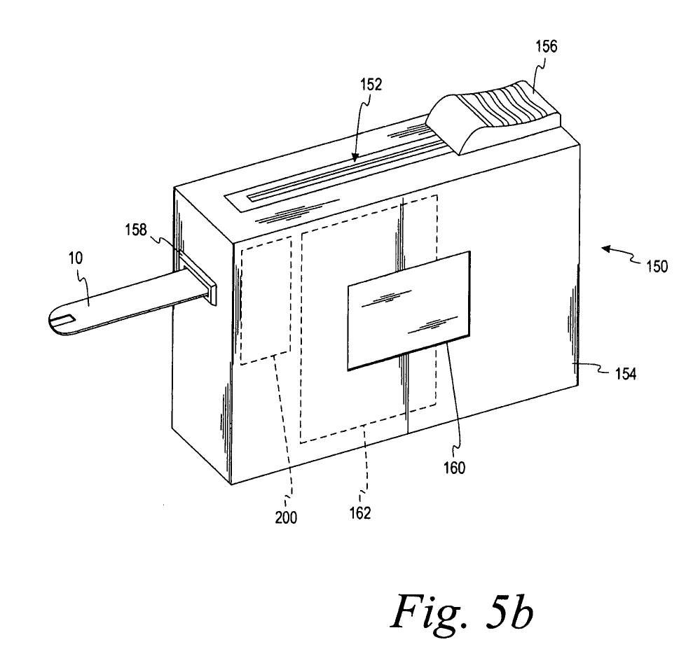

One non-limiting example of a meter or instrument that may be used with the test sensors of FIGS. 1-4 is shown in FIG. 5a. FIG. 5a depicts a single-sensor meter or instrument 100. The single-sensor meter 100 comprises a housing 104 that forms a test-sensor opening 108 of sufficient size to receive the second opposing end of a test sensor (e.g., second opposing end 22 of the test sensor 10). A test sensor in one method is adapted to be placed manually into the test-sensor opening 108. The meter uses, for example, the appropriate program number from the meter software after determining the end shape of the test sensor. The device housing may comprise an LCD screen 110 that displays, for example, analyte concentrations.

Another non-limiting example of a meter or instrument that may be used with the test sensors of FIGS. 1-4 is shown in FIG. 5b. FIG. 5b depicts a single-sensor meter or instrument 150. The single-sensor meter 150 comprises a sliding assembly 152 and housing 154. The sliding assembly 152 includes a slider 156 and a test sensor-extraction mechanism (not shown) that is attached to the slider 156. The housing 154 also forms a test-sensor opening 158 of sufficient size to receive the second opposing end of a test sensor (e.g., second opposing end 22 of the test sensor 10). The device housing may comprise an LCD screen 160 that displays, for example, analyte concentrations. In one method, the test sensor is adapted to be extracted from a test-sensor cartridge 162 and automatically placed in position to determine the auto-calibration of the test sensor. The meter uses, for example, the appropriate program number from the meter software after determining the end shape of the test sensor. It is contemplated that other meters or instruments may be used with the test sensors of FIGS. 1-4.

The meter or instrument (e.g., meters 100, 150) is adapted to detect the shape of the second opposing end after it is received in the test-sensor opening. The meter or instrument is then adapted to apply the auto-calibration information determined from the shape of the second opposing end and then apply the proper auto-calibration of the test sensor.

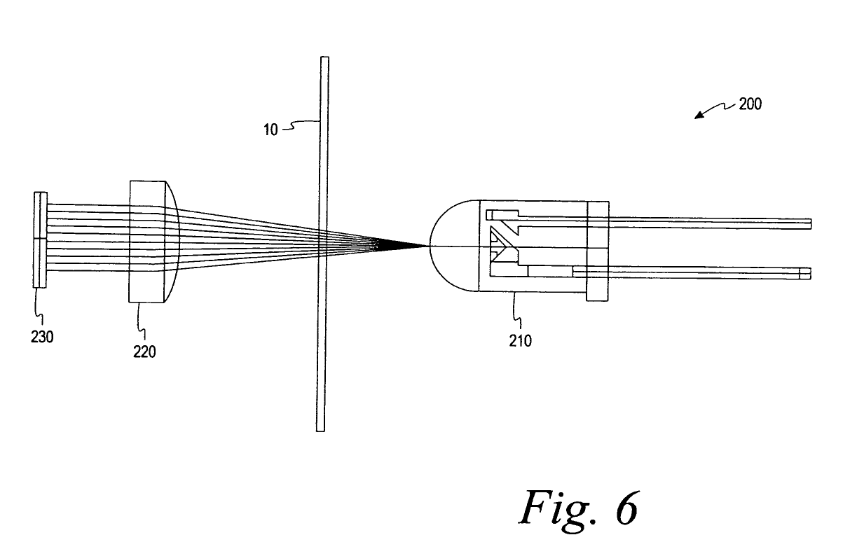

To determine the shape of the second opposing end, the meter or instrument may include an optical read head. One non-limiting example of an optical read head is shown in FIGS. 5, 6. Specifically, in FIG. 6, an optical read head 200 includes a light source 210, a lens 220 and a detector 230. In this embodiment, the light source 210 illuminates a test sensor (e.g., test sensor 10) and the lens 220 images the test sensor onto the detector 230. One example of a light source that may be used in the optical read head is a light-emitting diode (LED). It is contemplated that other light sources may be used in the optical read head such as, for example, a lamp. To inhibit or prevent light from transmitting through the test sensor, the lid and/or base is desirably opaque or at least generally opaque.

One example of a detector 230 that may be used in the optical read head 200 is a line-array detector. One commercial example of a line-array detector is a TAOS 64×1 linear-sensor array, TSL201R marketed by Texas Advanced Optoelectronic Solutions (TAOS), Inc. of Plano, Tex. This line-array detector has 64 discrete detectors. The shape of the second opposing end of the test sensor (e.g., test sensor 10) is imaged onto the 64 detector elements using the lens 220. The test sensor may be scanned when inserted or removed from the meter or instrument. An image of the sensor's second opposing end is constructed from the scans across the end.

The optical read head is adapted to detect the auto-calibration information and, if an optical test sensor is used, to detect a photometric color change of the first end (i.e., the testing end) of the test sensor. Thus, the optical read head is bi-functional.

It is contemplated that other optical read heads may be used in the present invention. Non-limiting examples of such detectors include an area-array detector, a discrete detector or a single-active element detector. A single-active element detector, for example, may not require a lens.

It is contemplated that the detecting of the shape of the second opposing end may be performed by methods other than optical detection. For example, in one method, the detecting of the second opposing end may be performed by a mechanical mechanism such as, for example, using mechanical switches and electronics to detect the shape of the second opposing end.

The test sensors of FIGS. 1-4 may be used as single stand-alone test sensors. The test sensors of FIGS. 1-4 may also be stored in a cartridge. Depending on the shape of the test sensors, it may be difficult, however, to excise different-shaped test sensors from cartridges in the same meter or instrument.

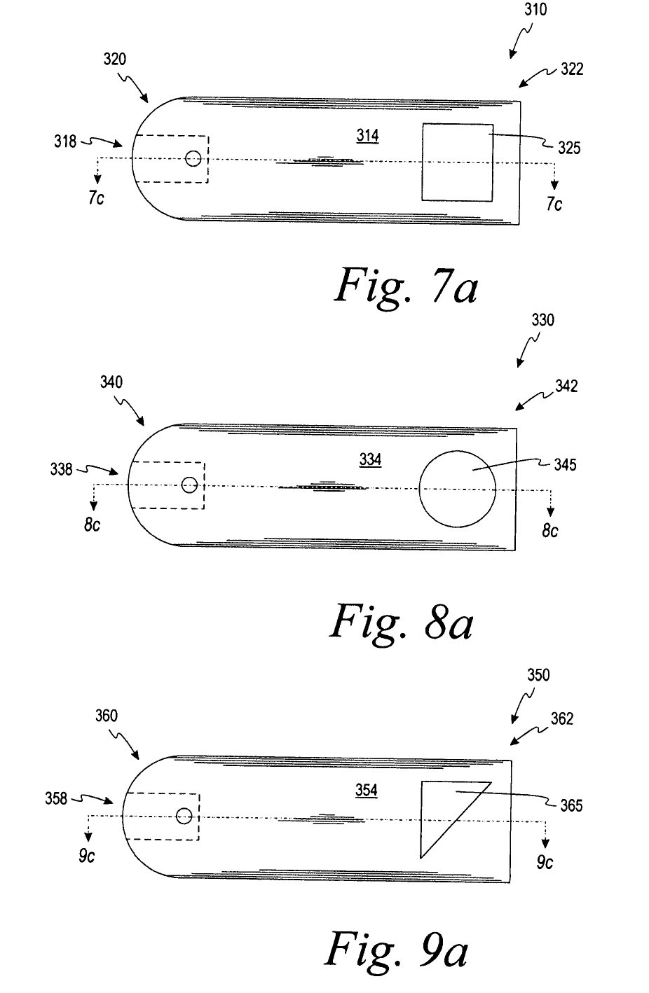

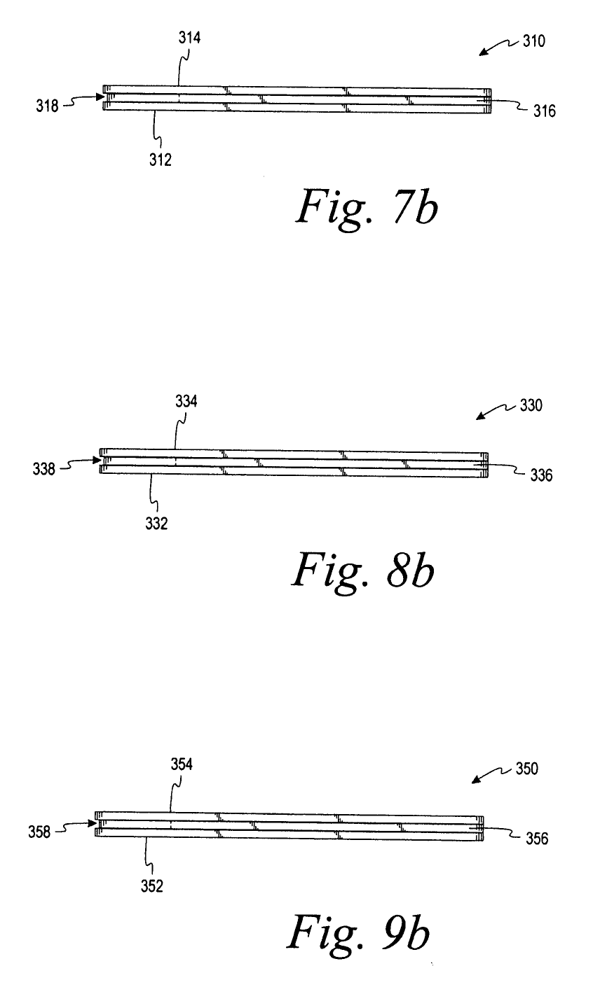

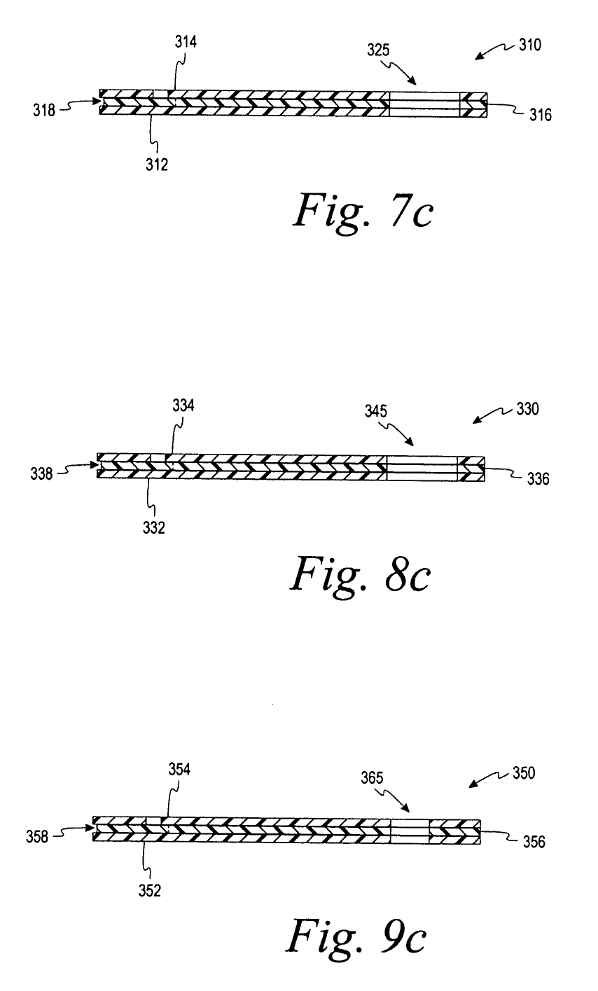

In another embodiment, a plurality of test sensors is formed with at least one cutout near or at the second opposing end such that the shape and/or dimensions of the cutout corresponds to auto-calibration information (e.g., the auto-calibration program number or code). For example, referring to FIGS. 7-9, a plurality of test sensors 310, 330 and 350 is shown. Each of the test sensors includes a base, a lid and a spacer with the spacer located between the lid and the spacer. Specifically, the test sensor 310 of FIGS. 7a-c includes a base 312, a lid 314 and a spacer 316. Similarly, the test sensor 330 of FIGS. 8a-c includes a base 332, a lid 334 and a spacer 336, while the test sensor 350 of FIGS. 9a-c includes a base 352, a lid 354 and a spacer 356. The base, lid and spacer may be made from a variety of materials such as the polymeric materials discussed above with respect to the test sensors 10, 30 and 50.

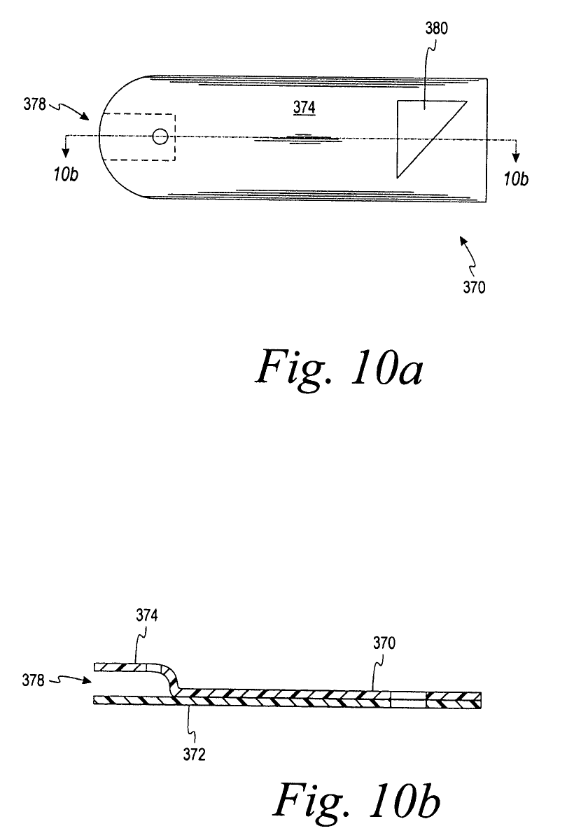

It is contemplated that the test sensors may be formed with a base and a lid in the absence of a spacer. In one such embodiment, a lid is formed to have a convex opening that is adapted to receive a fluid. A non-limiting example of such a test sensor is shown in FIGS. 10a, 10b. Specifically, in FIGS. 10a, 10b, a test sensor 370 includes a base 372 and a lid 374. When the lid 374 is attached to the base 372, a fluid-receiving area 378 is formed that is adapted to receive fluid for testing.

Referring back to FIG. 7b, when the base 312, the lid 314 and the spacer 316 are attached together, a fluid-receiving area 318 is formed. Similarly, in FIGS. 8b, 9b, respective fluid-receiving areas 338, 358 are formed when the respective base, lid and spacers are attached. The fluid-receiving areas provide a flow path for introducing the fluid sample into the test sensor. Referring back to FIG. 7a, the fluid-receiving area 318 is formed at a first end or testing end 320 of the test sensor 310. Similarly, in FIGS. 8a, 9a, the fluid-receiving areas 338, 358 are formed at a respective first end or testing end 340, 360 of their respective test sensor 330, 350.

The test sensors 310, 330, 350 and 370 may be optical test sensors. An indicator reagent system and an analyte in a sample of body fluid are reacted to produce a chromatic reaction—the reaction between the reagent and analyte causes the sample to change color. The degree of color change is indicative of the analyte concentration in the body fluid. The color change of the sample is evaluated to measure the absorbance level of the transmitted light.

It is also contemplated that the test sensors 310, 330, 350 and 370 may be electrochemical test sensors. In such an embodiment, the meter may have optical aspects so as to determine the auto-calibration information and electrochemical aspects to determine the analyte concentration of the fluid sample. The electrochemical test sensors typically include a plurality of electrodes and a fluid-receiving area that contains an enzyme.

The test sensors 310, 330 and 350 may be formed in a similar manner as described above in connection with the test sensor 10 of FIGS. 1a, 1b. For example, the base 312, the spacer 316, and the lid 314 of the test sensor 310 may be attached by, for example, an adhesive, heat sealing or the combination thereof. Similarly, the base 372 and the lid 374 may be attached by an adhesive, heat sealing or the combination thereof in forming the test sensor 370 of FIGS. 10a,b.

In addition to the first end or testing end of the test sensor, each of the test sensors includes a second opposing end. Referring to FIGS. 7a-c, the test sensor 310 includes a second opposing end 322. The second opposing end 322 is adapted to be placed into a meter or instrument. The second opposing end 322 of FIG. 7a forms a generally rectangular- or square-shaped cutout 325. The rectangular- or square-shaped cutout 325 extends through the test sensor 310 as shown in FIG. 7c. In another embodiment, the square-shaped cutout may extend through the lid and the spacer, but not the base. In this embodiment, it is desirable for the lid and the base to have sufficient contrast such that the optical read head can detect the cutout shape. In a further embodiment, the square-shaped cutout may extend through the lid, but not the spacer or the base. In this embodiment, it is desirable for the lid and the spacer to have sufficient contrast such that the optical read head can detect the cutout shape.

Similarly, the test sensor 330 of FIG. 8a includes a second opposing end 342. The second opposing end 342 is adapted to be placed into a meter or instrument. The second opposing end 342 forms a generally circular cutout 345. The test sensor 350 of FIG. 9a includes a second opposing end 362. The second opposing end 362 is adapted to be placed into a meter or instrument. The second opposing end 362 forms a generally triangular-shaped cutout 365. As discussed above, the cutouts may extend only through the lid and the spacer in one embodiment or just the lid itself in another embodiment.

The cutouts formed in the second opposing ends 322, 342 and 362 are formed to correspond with the auto-calibration information of the test sensor. The cutout shape of the second opposing end is varied in production such that a certain test sensor cutout shape corresponds to specific calibration information (e.g., an auto-calibration program number). Specifically, calibration information is determined and assigned for a particular test sensor. The calibration information for the test sensors 310, 330 and 350 was determined to be different. Because the calibration information was different, the cutout shapes formed in the second opposing ends were of different shapes. Thus, after the calibration information is assigned to a particular test sensor, the cutout shape formed in the second opposing end of the test sensor corresponds with the auto-calibration information. The auto-calibration information is used by a meter or instrument to determine how to calibrate the test sensor. For example, the meter detects the different cutout shapes of the test sensors and uses the appropriate program number from the meter software.

The auto-calibration information may be any information that can be used by a meter or instrument. For example, the auto-calibration information may be a program auto-calibration number that relates to a slope and intercept of calibration lines for the test sensor lot or batch. In addition to auto-calibration information, other information may be contained such an analyte type or manufacturing date.

The forming of a particular cutout shape in the second opposing end of a test sensor may be done by several methods. For example, the particular cutout shape of the second opposing end may be formed by cutting to a desired shape. The cutting may be done, by, for example, a laser. In another method, the particular cutout shape of the second opposing end may be formed by a punching operation such as using a punching tool.

In addition to the various end cutout shapes of the test sensors shown in FIGS. 7-9, it is contemplated that the cutouts of the second opposing ends of the test sensors may have other polygonal and non-polygonal shapes. It is also contemplated that the different calibration information may have smaller differences in the second opposing ends. For example, the cutouts formed in the second opposing ends may have minor differences in shape and/or dimensions that represent different auto-calibration information.

Similarly, different shaped opposing ends may be used with a test sensor that includes a base and a lid in the absence of a spacer (e.g., test sensor 370 with a generally rectangular-shaped cutout 380 of FIGS. 10a,b). For example, an opposing end may have a generally round shape, a generally square configuration or a triangular shape such as shown in FIGS. 1-3. It is contemplated that other polygonal and non-polygonal shapes may be used.

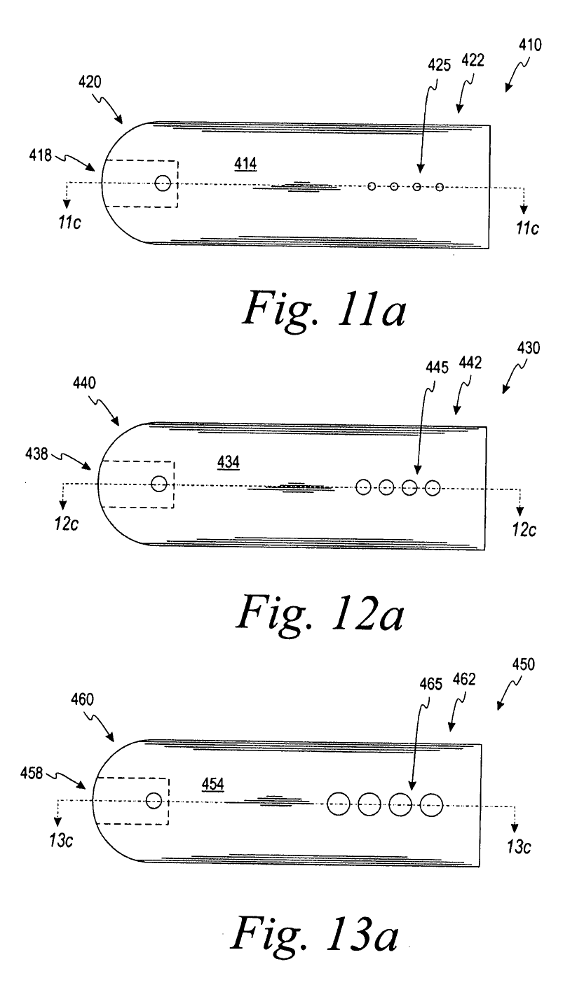

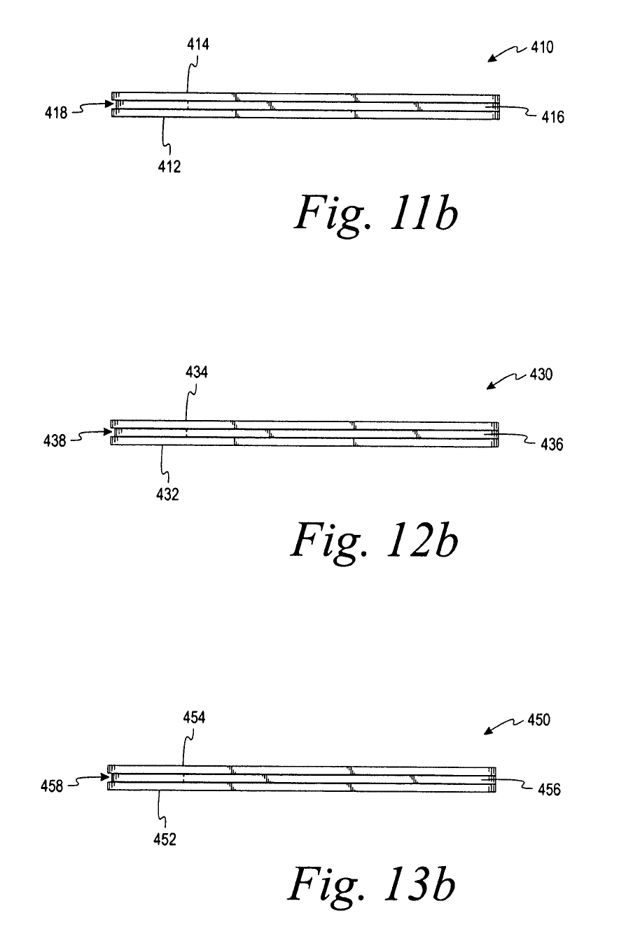

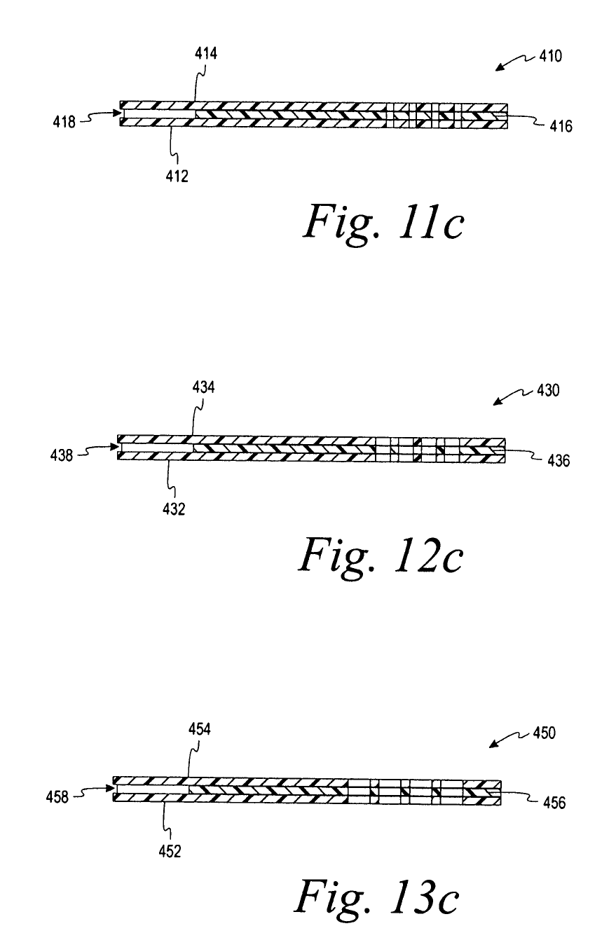

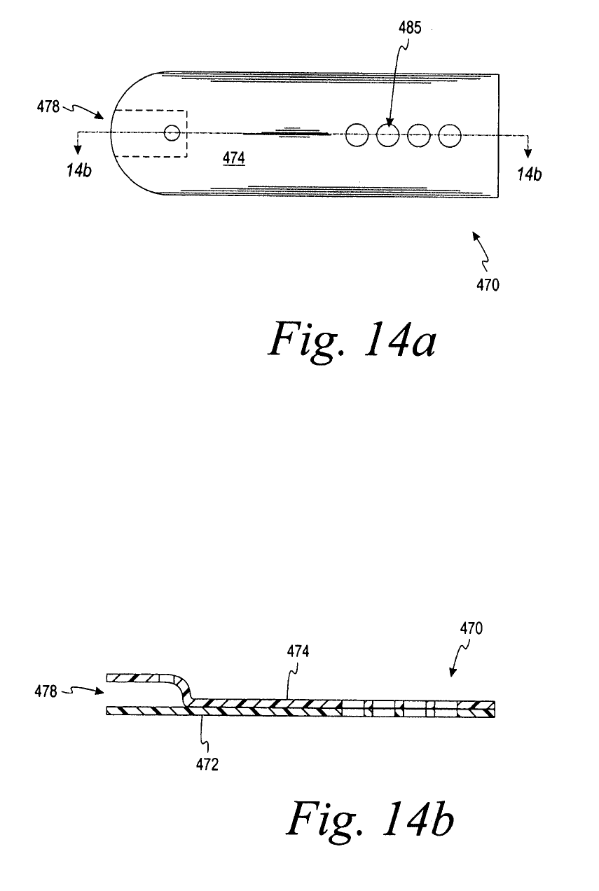

The test sensors 310, 330 and 350 of FIGS. 7-9 form exactly one cutout. It is contemplated that more than one cutout may be formed in the second opposing end of a test sensor. For example, in FIGS. 11-13, test sensors 410, 430 and 450 form a plurality of cutouts or apertures in a second opposing end thereof. Specifically, the test sensor 410 of FIG. 11a forms a plurality of apertures 425 located near an opposing second end thereof. Similarly, the test sensor 430 of FIG. 12a forms a plurality of apertures 445 and the test sensor 450 of FIG. 13a forms a plurality of apertures 465. The test sensor 470 of FIG. 14a forms a plurality of apertures 485. The plurality of apertures may be formed by methods such as punching or laser-cutting. The number, shape and/or dimensions of the apertures may be used to identify auto-calibration information of a test sensor.

In each of the test sensors of FIGS. 11-14, there are exactly four apertures formed therein, of which the diameters of the apertures 425, 445, 465, 485 vary. Each of the apertures is formed in a generally straight line. It is contemplated, however, that the apertures may be formed in other locations with respect to each other. For example, the apertures may be formed in a staggered line. The dimensions of the plurality of apertures 425, 445, 465 and 485 correspond to auto-calibration information (e.g., the auto-calibration program number or code). The number, shape and/or dimensions (e.g., diameter) of apertures may vary from that shown in FIGS. 11-13. In such embodiments, the number, shape and/or dimensions of the apertures may correspond to auto-calibration information.

Each of the test sensors 410, 430 and 450 includes a base, a lid and a spacer with the spacer located between the lid and the spacer. Specifically, the test sensor 410 of FIGS. 11a, 11b includes a base 412, a lid 414 and a spacer 416. Similarly, the test sensor 430 of FIGS. 12a, 12b includes a base 432, a lid 434 and a spacer 436, while the test sensor 450 of FIGS. 13a, 13b includes a base 452, a lid 454 and a spacer 456. The base, lid and spacer may be made from a variety of materials such as the polymeric materials discussed above with respect to the test sensors 10, 30 and 50.

It is contemplated that the test sensors may be formed with a base and a lid in the absence of a spacer. In one such embodiment, a lid is formed to have a convex opening that is adapted to receive a fluid. A non-limiting example of such a test sensor is shown in FIGS. 14a, 14b. Specifically, in FIGS. 14a, 14b, a test sensor 470 includes a base 472 and a lid 474. When the lid 474 is attached to the base 472, a fluid-receiving area 478 is formed that is adapted to receive fluid for testing.

Referring back to FIG. 11b, when the base 412, the lid 414 and the spacer 416 are attached together, a fluid-receiving area 418 is formed. Similarly, in FIGS. 12b, 13b, respective fluid-receiving areas 438, 458 are formed when the respective base, lid and spacers are attached. Referring back to FIGS. 11a, 11b, the fluid-receiving area 418 is formed at a first end or testing end 420 of the test sensor 410. Similarly, in FIGS. 12a, 13a, the fluid-receiving areas 438, 458 are formed at a respective first end or testing end 440, 460 of their respective test sensor 430, 450.

The test sensors 410, 430 and 450 may be formed in a similar manner as described above in connection with the test sensor 10 of FIGS. 11a, 11b. For example, the base 412, the spacer 416, and the lid 414 of the test sensor 410 may be attached by, for example, an adhesive, heat sealing or the combination thereof. Similarly, the test sensor 470 of FIGS. 14a,b may be formed by attaching the base 472 and the lid 474 via an adhesive, heat sealing or the combination thereof.

In addition to the first end or testing end of the test sensor, each of the test sensors includes a second opposing end. Referring to FIGS. 11a, 11b, the test sensor 410 includes a second opposing end 422. The second opposing end 422 is adapted to be placed into a meter or instrument. The second opposing end 422 of FIG. 11a forms a plurality of apertures 425 as discussed above.

Similarly, the test sensor 430 of FIG. 12a includes a second opposing end 442. The second opposing end 442 is adapted to be placed into a meter or instrument. The test sensor 450 of FIG. 13a includes a second opposing end 462. The second opposing end 462 is adapted to be placed into a meter or instrument.

The plurality of apertures 425, 445, 465 formed in respective second opposing ends 422, 442 and 462 are formed to correspond with the auto-calibration information of the test sensor. The number, shapes and/or dimensions of the plurality of apertures of the second opposing end is varied in production such that the apertures of a test sensor correspond to specific calibration information (e.g., an auto-calibration program number). Specifically, calibration information is determined and assigned for a particular test sensor. The calibration information for the test sensors 410, 430 and 450 was determined to be different. Because the calibration information was different, the number, shapes and/or dimensions of the plurality of apertures formed in the second opposing ends were different. Thus, after the calibration information is assigned to a particular test sensor, the number, shapes and/or dimensions of the plurality of apertures formed in the second opposing end of the test sensor corresponds with the auto-calibration information. The meter, for example, detects the different number, shapes and/or dimensions of the apertures formed in the test sensors and uses the appropriate program number from the meter software.

For example, the amplitude of the transmitted light and the number of areas transmitting light through the plurality of apertures 425, 445, 465 and 485 are used to provide calibration information. For example, in FIGS. 11-13, a combination of four apertures and three different aperture sizes results in 128 possible unique calibration codes.

The apertures may be read using an optical read head, such as the optical read head 200 of FIG. 6. If the apertures are of the same number and same shape (i.e., just different sizes), the optical read head may include a light source and a detector in the absence of a lens. One detector that may be used is a silicon detector having only one active-detection area. The apertures may be detected when the sensor is inserted or removed from the instrument. Because the apertures are of the same number and shape, the dimension (e.g., diameter) of the apertures may be determined by the intensity of the light transmitted therethrough.

In addition to the generally circular shapes of the apertures in FIGS. 11a-14a, it is contemplated that the apertures of the second opposing ends of the test sensors may have other polygonal and non-polygonal shapes.

The test sensors 410, 430, 450 and 470 may be optical test sensors. In one embodiment, the optical test sensor includes an indicator reagent system and an analyte in a sample of body fluid are reacted to produce a chromatic reaction—the reaction between the reagent and analyte caused the sample to change color. The degree of color change is indicative of the analyte concentration in the body fluid.

It is also contemplated that the test sensors 410, 430, 450 and 470 may be electrochemical test sensors. In such an embodiment, the meter may have optical aspects so as to determine the auto-calibration information and electrochemical aspects to determine the analyte concentration of the fluid sample. The electrochemical test sensors typically include a plurality of electrodes and a fluid-receiving area that contains an enzyme.

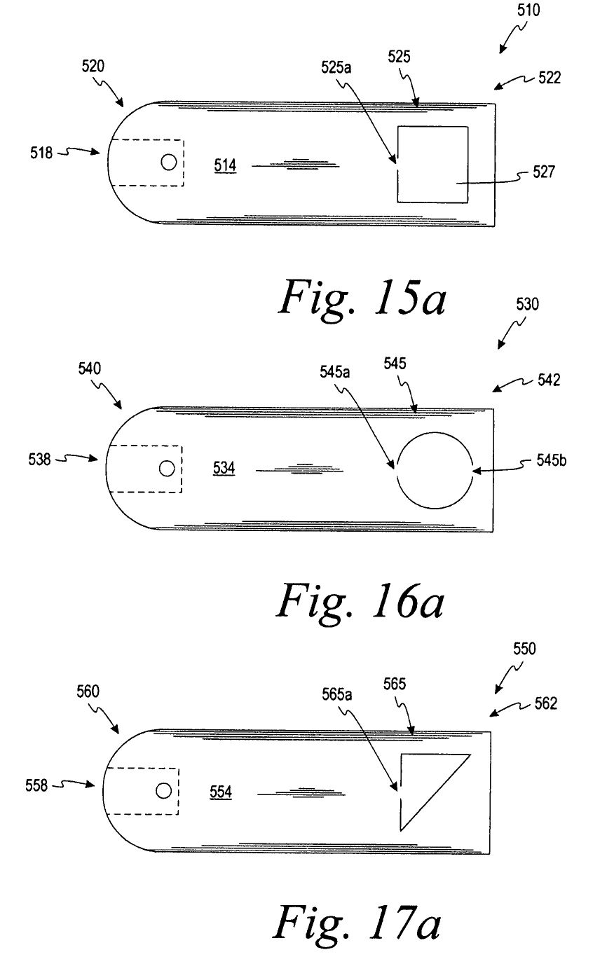

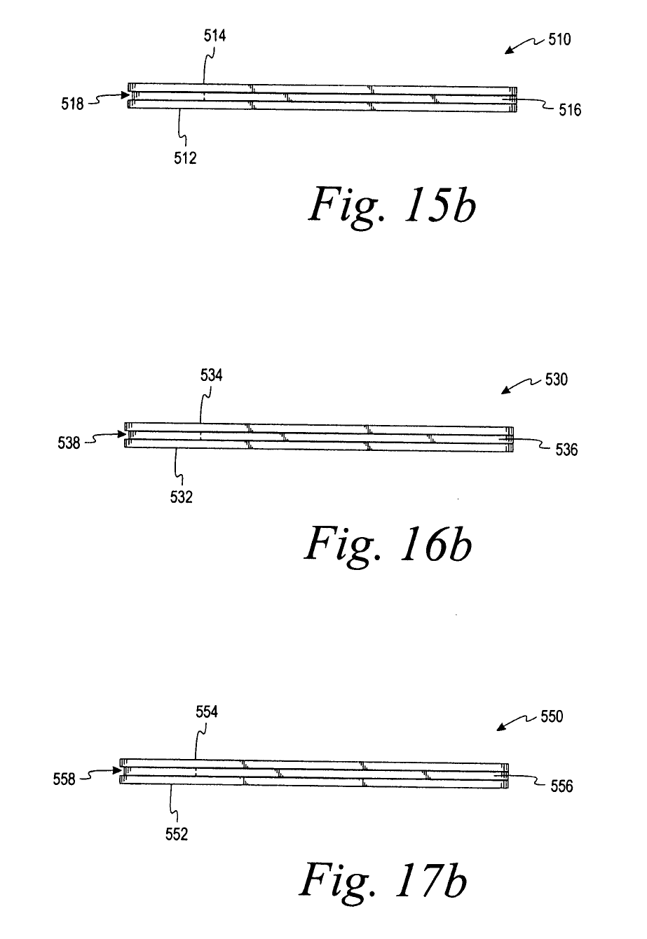

In another embodiment, a plurality of test sensors is formed with a partially cutout near or at the second opposing end such that the shape and/or dimensions of the partially cutout corresponds to auto-calibration information (e.g., the auto-calibration program number or code). For example, referring to FIGS. 15-17, a plurality of test sensors 510, 530 and 550 are shown. Each of the test sensors includes a base, a lid and a spacer with the spacer located between the lid and the spacer. Specifically, the test sensor 510 of FIGS. 15a, 15b includes a base 512, a lid 514 and a spacer 516. Similarly, the test sensor 530 of FIGS. 16a, 16b includes a base 532, a lid 534 and a spacer 536, while the test sensor 550 of FIGS. 17a, 17b includes a base 552, a lid 554 and a spacer 556. The base, lid and spacer may be made from a variety of materials such as the polymeric materials discussed above with respect to the test sensors 10, 30 and 50.

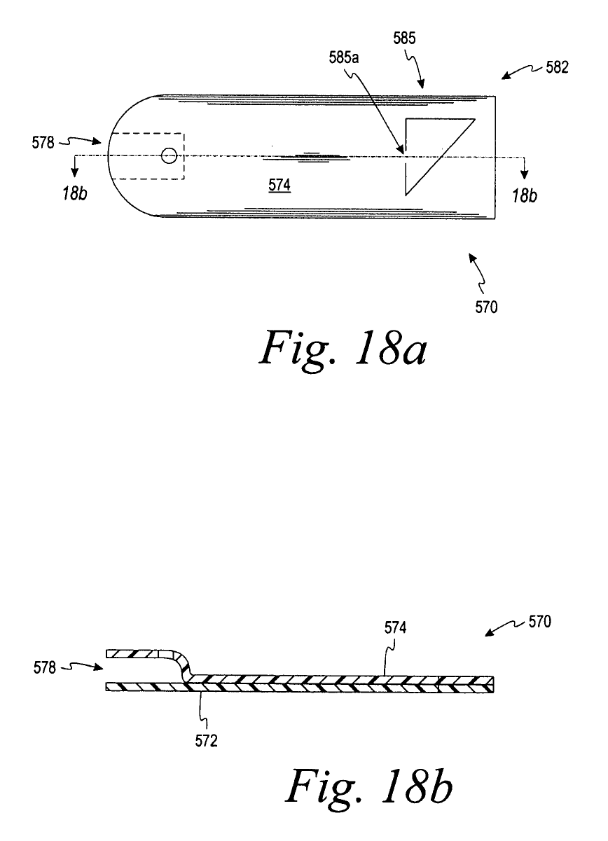

It is contemplated that the test sensors may be formed with a base and a lid in the absence of a spacer. In one such embodiment, a lid is formed to have a convex opening that is adapted to receive a fluid. A non-limiting example of such a test sensor is shown in FIGS. 18a, 18b. Specifically, in FIGS. 18a, 18b, a test sensor 570 includes a base 572 and a lid 574. When the lid 574 is attached to the base 572, a fluid-receiving area 578 is formed that is adapted to receive fluid for testing.

Referring back to FIG. 15b, when the base 512, the lid 514 and the spacer 516 are attached together, a fluid-receiving area 518 is formed. Similarly, in FIGS. 16b, 17b, respective fluid-receiving areas 538, 558 are formed when the respective base, lid and spacers are attached. Referring back to FIGS. 15a, 15b, the fluid-receiving area 518 is formed at a first end or testing end 520 of the test sensor 510. Similarly, in FIGS. 16b, 17b, the fluid-receiving areas 538, 558 are formed at a respective first end or testing end 540, 560 of their respective test sensor 530, 550.

In one embodiment, the test sensors of FIGS. 15-18 are optical test sensors. In another embodiment, the test sensors of FIGS. 15-18 are electrochemical test sensors.

The test sensors 510, 530 and 550 may be formed in a similar manner as described above in connection with the test sensor 10 of FIGS. 1a, 1b. For example, the base 512, the spacer 516, and the lid 514 of the test sensor 510 may be attached by, for example, an adhesive, heat sealing or the combination thereof. Similarly, the test sensor 570 of FIGS. 18a, 18b may be formed by attaching the base 572 and the lid 574 via an adhesive, heat sealing or the combination thereof.

In addition to the first end or testing end of the test sensor, each of the test sensors includes a second opposing end. Referring to FIGS. 15a, 15b, the test sensor 510 includes a second opposing end 522. The second opposing end 522 is adapted to be placed into a meter or instrument. The second opposing end 522 of FIG. 15a forms a generally rectangular- or square-shaped partial cutout 525. A partial cutout is a cutout in which at least one portion is not cut such that the non-cut material remains. In one embodiment, the partial cutout extends through the lid, spacer and the base. In another embodiment, the partial cutout extends through the lid and the spacer, but not the base. In a further embodiment, the partial cutout extends through the lid only, but not the spacer and the base.

For example, the partial cutout 525 of FIG. 15a has a portion 525a that has not been cut such that an interior portion 527 remains. A partial cutout 545 of FIG. 16a is formed near a second opposing end 542 and includes a first portion 545a and a second portion 545b that have not been cut. A partial cutout 565 of FIG. 17a is formed near a second opposing end 562 and includes a portion 565a that has not been cut. A partial cutout 585 of FIG. 18a is formed near a second opposing end 582 and includes a portion 585a that has not been cut.

The partial cutouts formed in the second opposing ends 522, 542, 562 and 582 are formed to correspond with the auto-calibration information of the test sensor. The partial cutout shape of the second opposing end is varied in production such that a partial cutout shape of a test sensor corresponds to specific calibration information (e.g., an auto-calibration program number). Specifically, calibration information is determined and assigned for a particular test sensor. The calibration information for the test sensors 510, 530 and 550 was determined to be different. Because the calibration information was different, the partial cutout shapes formed in the second opposing ends were different. Thus, after the calibration information is assigned to a particular test sensor, the partial cutout shape is formed in the second opposing end of the test sensor to correspond with the auto-calibration information.

The forming of a particular partial cutout shape in the second opposing end of a test sensor may be done by several methods. For example, the specific partial cutout shape of the second opposing end may be formed by cutting to a desired shape. The cutting may be done, by, for example, a laser such as a laser-ablation method. It is contemplated that other methods may be used to form the partial cutouts of FIGS. 15-18.

In addition to the various partial cutout shapes of the test sensors shown in FIGS. 15-18, it is contemplated that the partial cutouts formed in the second opposing ends of the test sensors may have other polygonal and non-polygonal shapes. It is also contemplated that the different calibration information may have smaller differences in the second opposing ends. For example, the cutouts formed in the second opposing ends may have minor differences in shape and/or dimensions that represent different auto-calibration information.

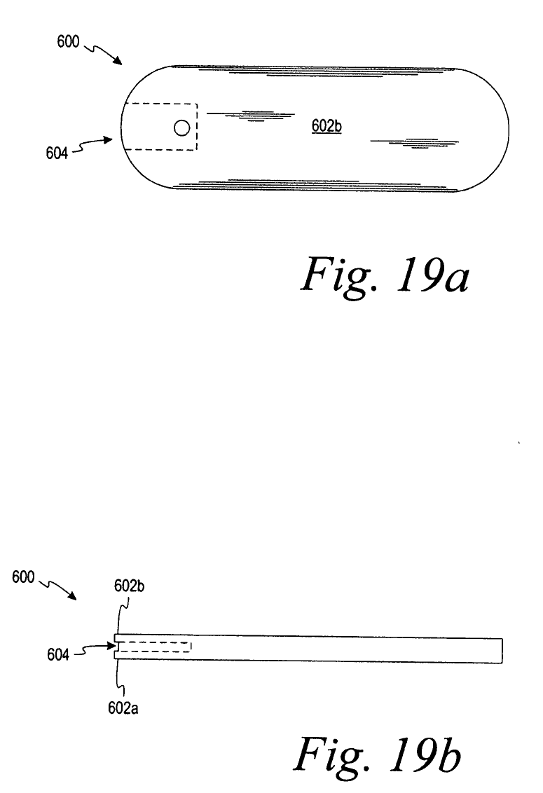

It is contemplated that the test sensor may be formed from an integrated lid portion and a base portion. For example, FIGS. 19a,b disclose a test sensor 600 that includes a base portion 602a and a lid portion 602b that forms a fluid-receiving area 604. The base and lid portions 602a, 602b are integrally formed with each other. The test sensor 600 functions in a similar manner as the test sensor 10 of FIG. 1a discussed above. The integrated test sensor may have different shaped opposing second ends as discussed above that correspond with the auto-calibration information.

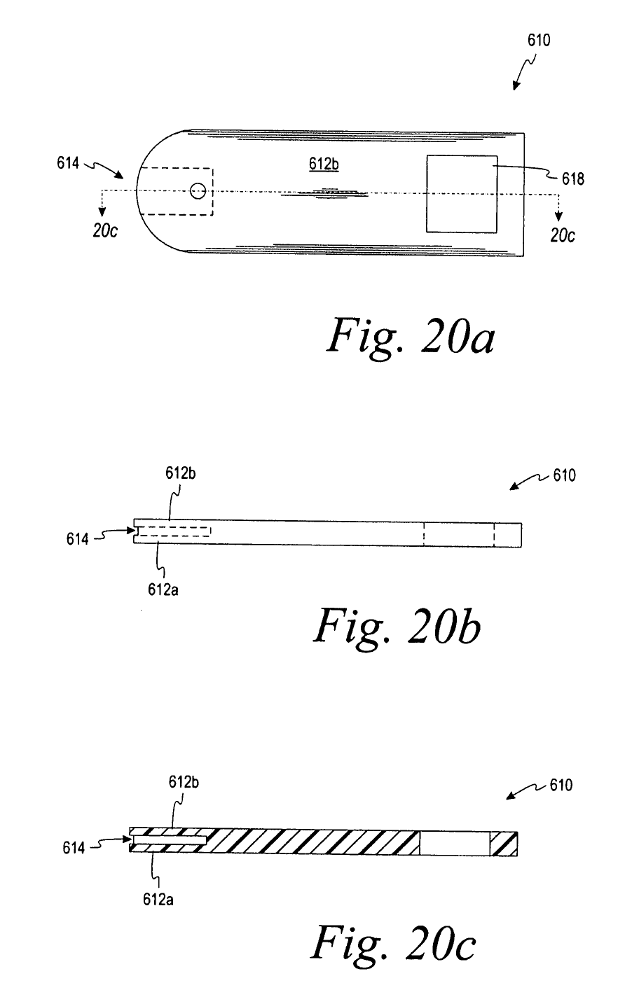

In another example, FIGS. 20a-c disclose a test sensor 610 that includes a base portion 612a and a lid portion 612b that forms a fluid-receiving area 614. The base portion 612a and the lid portion 612b are integrally formed with each other. The test sensor 610 also forms a cutout 618 that corresponds with the auto-calibration information. The test sensor 610 functions in a similar manner as the test sensor 310 of FIG. 7a discussed above.

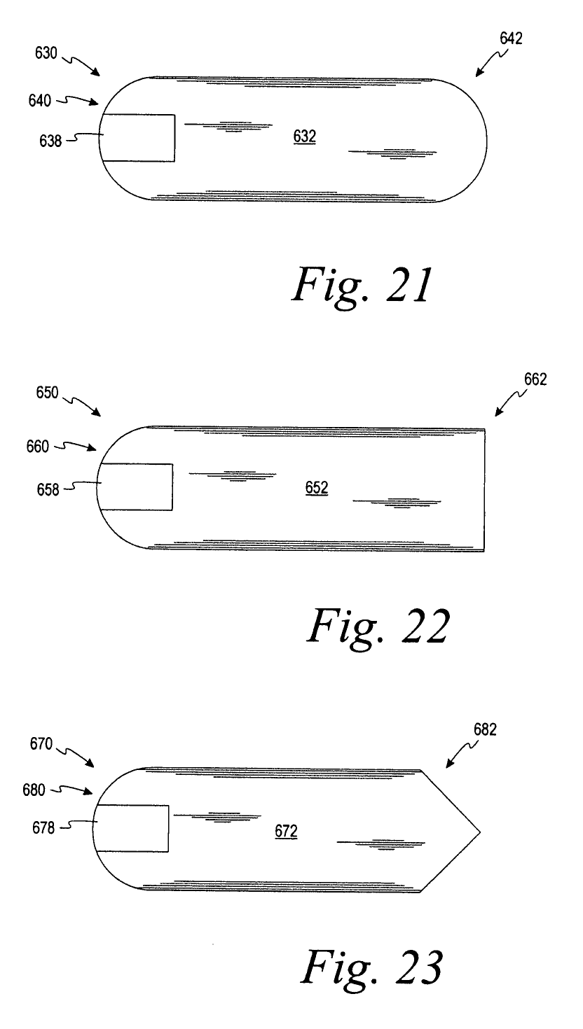

It is also contemplated that the test sensors may be formed using a single base layer. Referring to FIGS. 21-23, test sensors 630, 650 and 670 are shown in which each of the test sensors are formed from a single layer. Each of the test sensors includes a respective base 632, 652 and 672 in the absence of a lid. The base may be made from a variety of materials such as polymeric materials. The test sensors include a fluid-receiving area on the base surface that is adapted to receive a fluid sample. Specifically, test sensor 630 of FIG. 21 includes a fluid-receiving area 6358. The test sensors 650 and 670 of FIGS. 22, 23 include respective fluid-receiving areas 658 and 678.

Referring back to FIG. 21, the fluid-receiving area 638 is formed at a first end or testing end 640 of the test sensor 630. Similarly, in FIGS. 22, 23, the fluid-receiving areas 658, 678 are formed at a respective first end or testing end 660, 680 of their respective test sensor 650, 670. The test sensors of FIGS. 21-23 may be optical or electrochemical test sensors as discussed above. If an electrochemical test sensor, the meter has optical aspects so as to determine the auto-calibration information and electrochemical aspects to determine the analyte concentration of a fluid sample.

In addition to the first end or testing end of the test sensor, each of the test sensors includes a second opposing end. Referring to FIG. 21, the test sensor 630 includes a second opposing end 642. The second opposing end 642 is adapted to be placed into a meter or instrument. The second opposing end 642 of FIG. 21 is generally round shaped. Similarly, the test sensor 650 of FIG. 22 includes a second opposing end 662. The second opposing end 662 is adapted to be placed into a meter or instrument. The second opposing end 662 is shown as being generally rectangular-shaped end. The test sensor 670 of FIG. 23 includes a second opposing end 682. The second opposing end 682 is adapted to be placed into a meter or instrument. The second opposing end 682 is shown as being generally triangular-shaped end.

The shapes of the second opposing ends 642, 662 and 682 are formed to correspond with the auto-calibration information of the test sensor. The shapes of the test sensors 630, 650 and 670 function in a similar manner as the test sensors 10, 30 and 50 discussed above. Different shaped opposing ends may be used with a single layer test sensor. The test sensors may be adapted to be used with a meter or instrument such as shown in FIG. 5a or 5b.

The test sensors of FIGS. 21-23 may be used as single stand-alone test sensors. The test sensors of FIGS. 21-23 may also be stored in a cartridge. Depending on the shape of the test sensors, it may be difficult, however, to excise different-shaped test sensors from cartridges in the same meter or instrument.

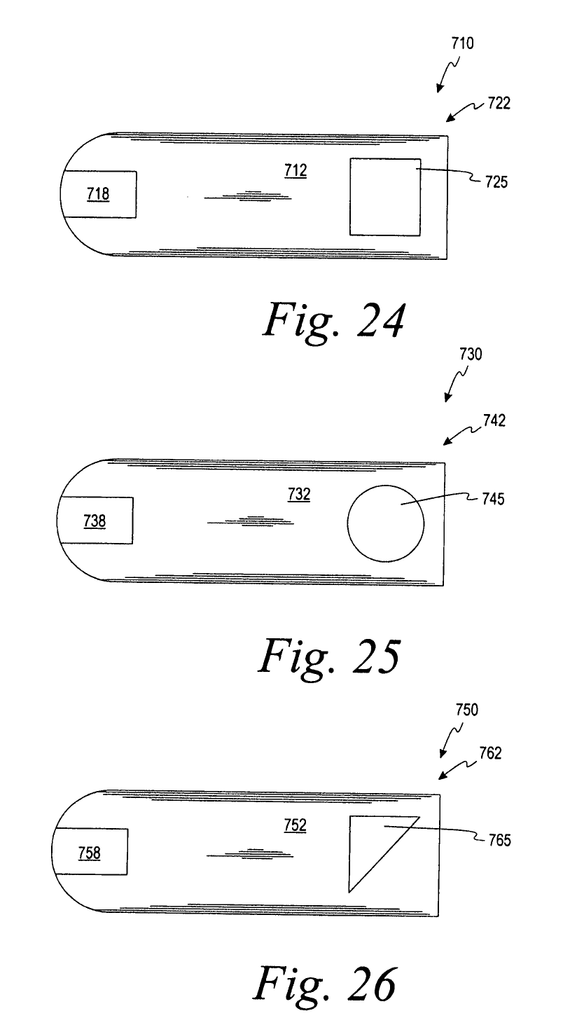

In another embodiment, a plurality of test sensors is formed with at least one cutout near or at the second opposing end such that the shape and/or dimensions of the cutout corresponds to auto-calibration information (e.g., the auto-calibration program number or code). For example, referring to FIGS. 24-26, a plurality of test sensors 710, 730 and 750 is shown. Each of the test sensors 710, 730 and 750 is made of one layer (respective bases 712, 732, 752). Thus, test sensors 710, 730 and 750 of FIGS. 24-26 are formed in the absence of a lid. Each of the test sensors 710, 730 and 750 include respect fluid-receiving areas 718, 738 and 758. The test sensors of FIGS. 24-26 may be optical or electrochemical test sensors.

In addition to a first end or testing end of the test sensor, each of the test sensors includes a second opposing end. Referring to FIG. 24, the test sensor 710 includes a second opposing end 722. The second opposing end 722 is adapted to be placed into a meter or instrument. The second opposing end 722 forms a generally rectangular- or square-shaped cutout 725. The rectangular- or square-shaped cutout 725 extends through the test sensor 710. Similarly, the test sensor 730 of FIG. 25 includes a second opposing end 742. The second opposing end 742 is adapted to be placed into a meter or instrument. The second opposing end 742 forms a generally circular cutout 745. The test sensor 750 of FIG. 26 includes a second opposing end 762. The second opposing end 762 is adapted to be placed into a meter or instrument. The second opposing end 762 forms a generally triangular-shaped cutout 765.

The cutouts formed in the second opposing ends 722, 742 and 762 are formed to correspond with the auto-calibration information of the test sensor. These cutouts function and are formed in a similar manner as the cutouts 325, 345 and 365 of FIGS. 7a-9a.

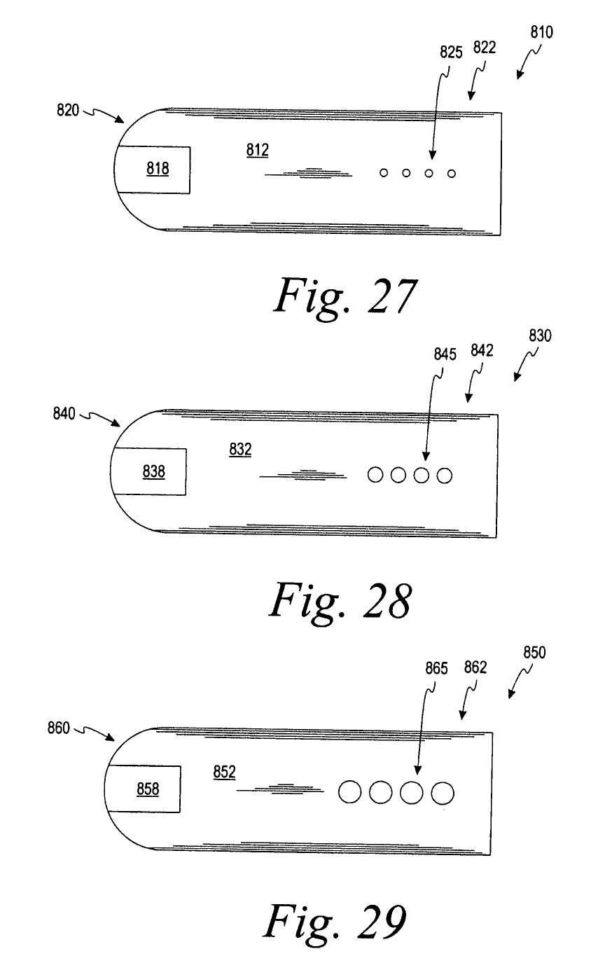

The single-layer test sensors 710, 730 and 750 of FIGS. 24-26 form exactly one cutout. It is contemplated that more than one cutout may be formed in the second opposing end of a single-layer test sensor. For example, in FIGS. 27-29, test sensors 810, 830 and 850 form a plurality of cutouts or apertures in a second opposing end thereof. Each of the test sensors of FIGS. 27-29 includes exactly one layer—respective bases 812, 832, and 852. Specifically, the test sensor 810 of FIG. 27 forms a plurality of apertures 825 located near an opposing second end 822 thereof. Similarly, the test sensor 830 of FIG. 28 forms a plurality of apertures 845 near an opposing second end 842 thereof and the test sensor 850 of FIG. 29 forms a plurality of apertures 865 near an opposing second end 862 thereof. The plurality of apertures may be formed by methods such as punching or laser-cutting. The number, shape and/or dimensions of the apertures may be used to identify auto-calibration information of a test sensor.

In each of the test sensors of FIGS. 27-29, there are exactly four apertures formed therein, of which the diameters of the apertures 825, 845, 865 vary. The apertures function and are formed in a similar manner as described above with respect to the apertures of test sensors 420, 440 and 460 of FIGS. 11-13.

The test sensors of FIGS. 27-29 include respective fluid-receiving areas 818, 838 and 858. Referring back to FIG. 27, the fluid-receiving area 818 is formed at a first end or testing end 820 of the test sensor 810. Similarly, in FIGS. 28, 29, the fluid-receiving areas 838, 858 are formed at a respective first end or testing end 840, 860 of their respective test sensor 830, 850. In addition to the first end or testing end of the test sensor, each of the test sensors includes a second opposing end. Referring to FIG. 27, the test sensor 810 includes a second opposing end 822. The second opposing end 822 is adapted to be placed into a meter or instrument. The second opposing end 822 forms a plurality of apertures 825 as discussed above. Similarly, the test sensor 830 of FIG. 28 includes a second opposing end 842. The second opposing end 842 is adapted to be placed into a meter or instrument. The test sensor 850 of FIG. 29 includes a second opposing end 862. The second opposing end 862 is adapted to be placed into a meter or instrument. The test sensors of FIGS. 27-29 may be optical test sensors or electrochemical test sensors as discussed above.

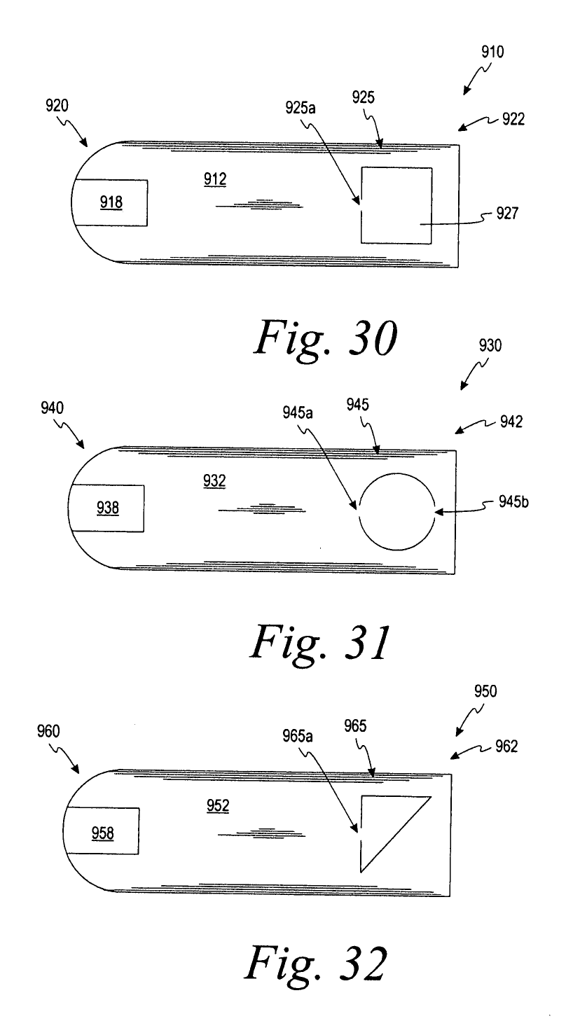

In another embodiment, a plurality of test sensors is formed with a partially cutout near or at the second opposing end such that the shape and/or dimensions of the partially cutout corresponds to auto-calibration information (e.g., the auto-calibration program number or code). For example, referring to FIGS. 30-32, a plurality of test sensors 910, 930 and 950 is shown. Each of the test sensors 910, 930 and 950 includes one layer (respective bases 912, 932 and 952). In one embodiment, the test sensors of FIGS. 30-32 are optical test sensors. In another embodiment, the test sensors of FIGS. 30-32 are electrochemical test sensors.

The test sensors 910, 930 and 950 include respective fluid-receiving areas 918, 938 and 958 is formed. Referring back to FIG. 30, the fluid-receiving area 918 is formed at a first end or testing end 920 of the test sensor 910. Similarly, in FIGS. 31, 32, the fluid-receiving areas 938, 958 are formed at a respective first end or testing end 940, 960 of their respective test sensor 930, 950. In addition to the first end or testing end of the test sensor, each of the test sensors includes a second opposing end. Referring to FIG. 30, the test sensor 910 includes a second opposing end 922. The second opposing end 922 is adapted to be placed into a meter or instrument. The second opposing end 922 forms a generally rectangular- or square-shaped partial cutout 925. For example, the partial cutout 925 of FIG. 30 has a portion 925a that has not been cut such that an interior portion 927 remains. The partial cutout 945 of FIG. 31 is formed near a second opposing end 942 and includes a first portion 945a and a second portion 945b that have not been cut. The partial cutout 965 of FIG. 32 is formed near a second opposing end 962 and includes a portion 965a that has not been cut.

The partial cutouts formed in the second opposing ends 922, 942 and 962 are formed to correspond with the auto-calibration information of the test sensor. The partial cutout shape of the second opposing end is varied in production such that a partial cutout shape of a test sensor corresponds to specific calibration information (e.g., an auto-calibration program number). Specifically, calibration information is determined and assigned for a particular test sensor. The calibration information for the test sensors 910, 930 and 950 was determined to be different. Because the calibration information was different, the partial cutout shapes formed in the second opposing ends were different. Thus, after the calibration information is assigned to a particular test sensor, the partial cutout shape is formed in the second opposing end of the test sensor to correspond with the auto-calibration information.

In one non-limiting example, an electrochemical test sensor includes at least a base, a plurality of electrodes and at least one reagent. The base includes a first end and an opposing second end. The plurality of electrodes is formed on the base at or near the first end. In this example, the plurality of electrodes includes a working electrode and a counter electrode. The at least one reagent is positioned at or near the first end so as to contact the fluid sample. The test sensor includes a first end and an opposing second end. The test sensor has a non-conductive, auto-calibration area. Specifically, the auto-calibration area has non-conductive markings in a form of a pattern corresponding to auto-calibration information. The markings are adapted to be optically detected.

A fluid sample (e.g., blood) is applied to a fluid-receiving area and the fluid sample reacts with the at least one reagent. The fluid sample after reacting with the reagent and in conjunction with the plurality of electrodes produces electrical signals that assist in determining the analyte concentration. In one embodiment, the electrochemical test sensor further includes conductive leads. The conductive leads carry the electrical signal back towards the second opposing end of the test sensor where meter contacts transfer the electrical signals into the meter.

Referring to FIG. 33, an electrochemical test sensor 1000 is shown according to one embodiment. The electrochemical test sensor includes a base 1002, a plurality of electrodes 1004a, 1004b and at least one reagent 1006. The base 1002 includes a first end 1002a and an opposing second end 1002b. The plurality of electrodes 1004a, 1004b is formed on the base 1002 at or near the first end 1002a. The plurality of electrodes 1004a, b includes a respective working electrode and a counter electrode in one embodiment. The at least one reagent 1006 is positioned at or near the first end 1002a.

The test sensor 1000 further includes a non-conductive, auto-calibration area 1010. Specifically, the auto-calibration area 1010 has a plurality of non-conductive markings 1020 corresponding to auto-calibration information. The markings 1020 are in a pattern that is adapted to be optically detected. In FIG. 33, the auto-calibration area 1010 is located beyond the meter contacts (a plurality of generally circular areas 1012 of the test sensor 1000 is contacted by the meter contacts).

In one embodiment, the auto-calibration area 1010 initially includes a generally uniform color or shade before the markings 1020 are formed. The markings 1020 in this embodiment are formed of a different color or shade from the remainder of the area 1010. Specifically, the markings 1020 are of a contrasting color or shade that can be interpreted by the meter or instrument as the auto-calibration code. The markings may be transparent or translucent in one embodiment.

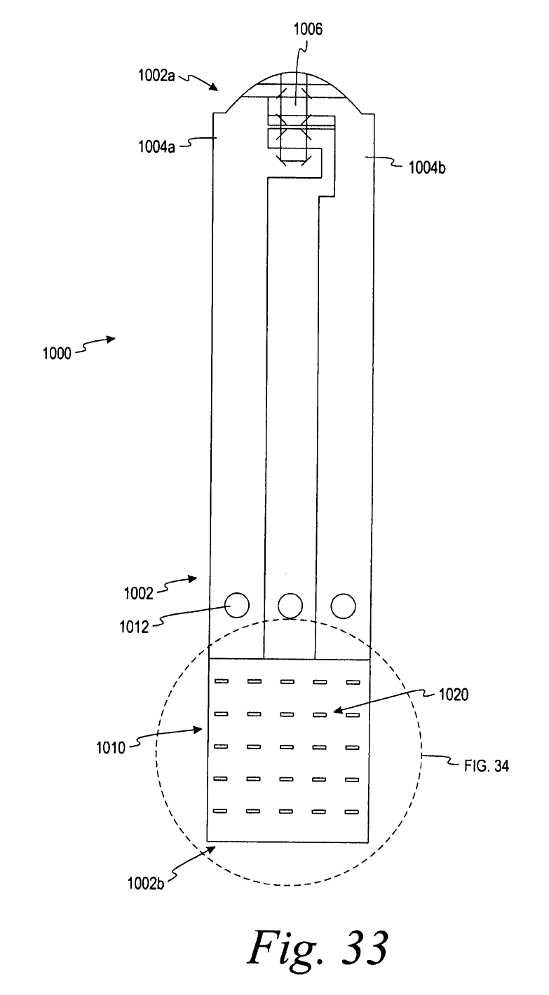

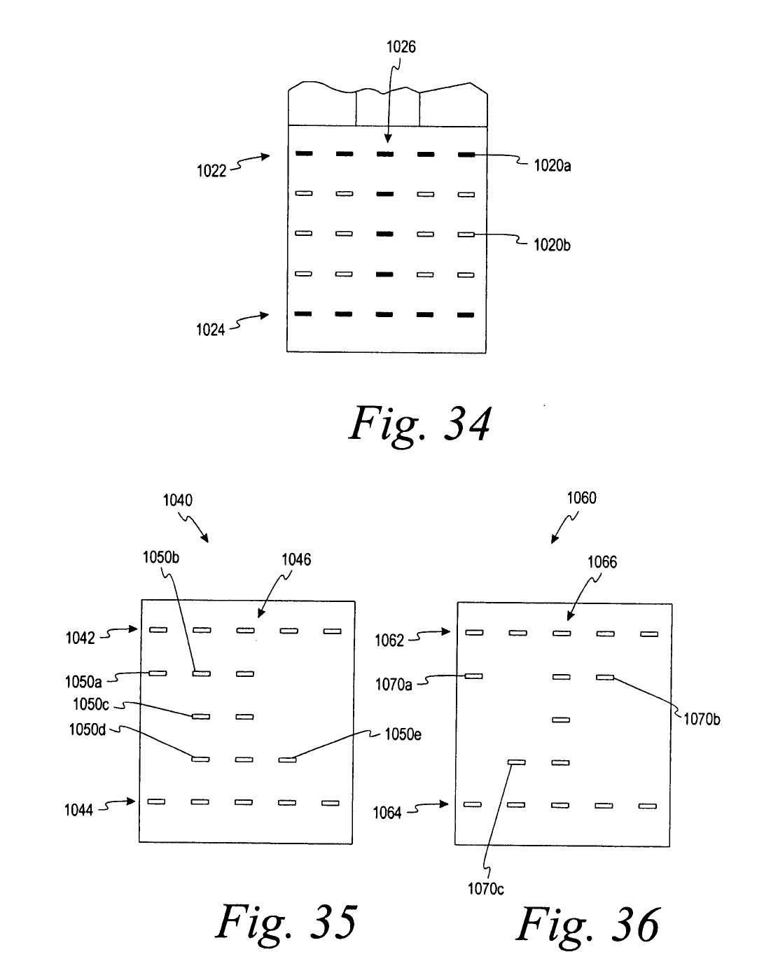

The auto-calibration area 1010 is shown in an enlarged view in FIG. 34. In this embodiment, the auto-calibration area 1010 includes a first set of constant markings 1020a and a second set of variable markings 1020b. To better differentiate the constant markings 1020a from the variable markings 1020b in FIG. 34, the constant markings 1020a are shown as darkened rectangles, while the variable markings 1020b are shown as non-darkened rectangles. The first set of constant markings 1020a are marked in every one of the test sensors.

In this embodiment, the uppermost and lowermost rows 1022, 1024 are constant markings 1020a. Additionally, in this embodiment, the middle or central column 1026 is formed of constant markings 1020a. These constant markings 1020a serve as a check on the detector response. The center column 1026 acts as a timing control or check for each row of markings. When the detector sees a marking at the center column 1026, there should be a marking or no marking at all other positions along that row. The second set of variable markings 1020b, however, may or may not be marked depending on the auto-calibration information that is to be conveyed to the meter. In this example, there are twelve variable markings 1020b that may or may not be marked.

In one embodiment, the markings 1020 are of a different color than the remainder of the auto-calibration area 1010. For example, the constant markings 1020a are black, the variable markings 1020b are marked black or white, depending on the auto-calibration code, while the remainder of the auto-calibration area is white.

It is contemplated that the number of constant and variable markings 1020a, 1020b may vary from the number shown in FIG. 34. For example, the markings may consist of only variable markings. It is also contemplated that the placement of the constant markings 1020a and the variable markings 1020b may be located differently than shown in FIG. 34.

The number of columns of the markings is selected on considerations such as the accuracy of the placement of the markings (e.g., the placement of the columns and rows), the resolution of the optical detector, and the width of the test sensor. For example, one optical detector array (TAOS 64×1 linear-sensor array, TSL201R marketed by Texas Advanced Optoelectronic Solutions (TAOS), Inc. of Plano, Tex.) has about 200 detectors/inch, 70 μm wide photodiodes that are spaced 125 μm apart. In one electrochemical test sensor, the auto-calibration markings formed with a laser have a width of from about 4 to about 6 mils with the width of the electrochemical test sensor being about 250 mils. Using such a test sensor, five columns may be marked with markings of from about 10 to about 20 mils that are spaced about 40 mils apart.

Referring to FIGS. 35 and 36, representative examples of auto-calibration areas 1040 and 1060 are shown. Referring initially to FIG. 35, the auto-calibration area 1040 includes constant and variable markings. The auto-calibration area 1040 includes variable markings 1050a-e, while the constant markings are the remainder of the markings, which are located in rows 1042, 1044 and column 1046. Referring to FIG. 36, the auto-calibration area 1060 also includes constant and variable markings. The auto-calibration area 1060 includes variable markings 1070a-c, while the constant markings are the remainder of the markings, which are located in rows 1062, 1064 and column 1066.

The auto-calibration areas (e.g., the auto-calibration area 1010 of FIG. 33) is shown as being on the base on the same side of the test sensor as the plurality of electrodes. It is contemplated that the auto-calibration area may be formed on an opposing surface of the base as the plurality of electrodes.

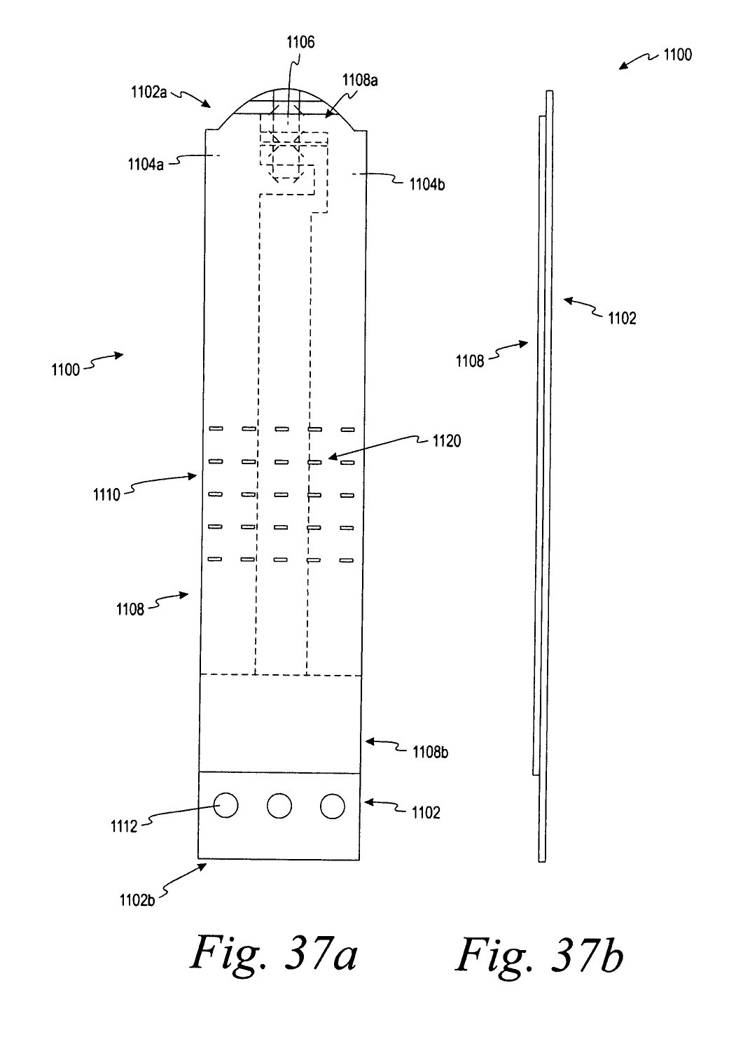

In another embodiment, an electrochemical sensor 1100 of FIGS. 37a, b includes a base 1102, a plurality of electrodes 1104a, 1104b, at least one reagent 1106 and a lid 1108. The base 1102 includes a first base end 1102a and an opposing second base end 1102b. The plurality of electrodes 1104a, 1104b is formed on the base 1102 at or near the first end 1102a. The plurality of electrodes 1104a, b includes a respective working electrode and a counter electrode in one embodiment. The at least one reagent 1106 is positioned at or near the first end 1102a.

The lid 1108 includes a first end 1108a and a second opposing end 1108b. The lid 1108 includes a non-conductive, auto-calibration area 1110. Specifically, the auto-calibration area 1110 includes a plurality of non-conductive markings 1120 corresponding to auto-calibration information. The markings 1120 are similar to the markings 1020 described above in connection with FIGS. 33, 34. The markings 1120 are in a pattern and correspond to auto-calibration information that is adapted to be optically detected. The markings 1120 may include the constant and variable markings described above in FIGS. 34-36. In this embodiment, the auto-calibration markings are located in the general middle area of the test sensor. It is contemplated that the auto-calibration area on the lid may be located in different areas. For example, the auto-calibration markings may be located at or near the opposing second lid end 1108b.

The auto-calibration markings (e.g., markings 1020), when known, may be formed in an in-line process. In this method, the test sensors are formed in a web or sheet and then the calibration information (e.g., a certain program number or code) is marked in the auto-calibration area. The markings may be formed by, for example, ablation where material is removed to expose visually different underlying material, or the use of irradiation that causes a visually distinct change to the substrate surface. The markings can be made sequentially by, for example, using a single narrow beam that is rastered, or simultaneously by, for example, illumination of the whole marking field. Other marking methods that may be used include cutting, punching and printing. It is contemplated that the markings may be formed by other methods. The markings may be optically detected using a transmission or reflective system.

In one specific example, a generally white base or substrate is used. A CO₂ laser marks the auto-calibration markings onto a polymeric sheet (e.g., a polycarbonate sheet incorporating mica that is designed to darken on exposure to laser light). In this example, the optical detector may use a reflective method with a light source on the same side of the base or substrate. In this example, the auto-calibration markings would be of a darker color (e.g., black).

In another specific example, a generally white base or substrate is used having a black or opaque surface layer. A YAG, excimer (UV) or CO₂ laser may be used to ablate this surface layer. In this example, the optical detector may use a reflective method with a light source on the same side of the base or substrate. In this example, the auto-calibration markings would be of a lighter color (e.g., white).

In another example, the auto-calibration markings may be ablated onto a black or opaque surface. In this example, a YAG excimer (UV) or CO₂ laser may be used with a metalized surface such as palladium or gold. In this embodiment, the detector may use a transmission process with the light source being located on the other side of the base or substrate, shining through the ablated markings.

In another embodiment, an optical test sensor is adapted to determine an analyte concentration of a fluid sample. The optical test sensor comprises a base, a fluid-receiving area and at least one reagent. The base includes a first base end and an opposing second base end. The fluid-receiving area is adapted to receive a fluid sample. The fluid-receiving area is located near or at the first base end. At least one reagent is positioned to contact the fluid sample in the fluid-receiving area. The at least one reagent assists in optically determining the analyte concentration of the fluid sample. The optical test sensor includes a first end and an opposing second end. The optical test sensor has a non-conductive, auto-calibration area. The auto-calibration area has markings in a form of a pattern corresponding to auto-calibration information. The markings are adapted to be optically detected.

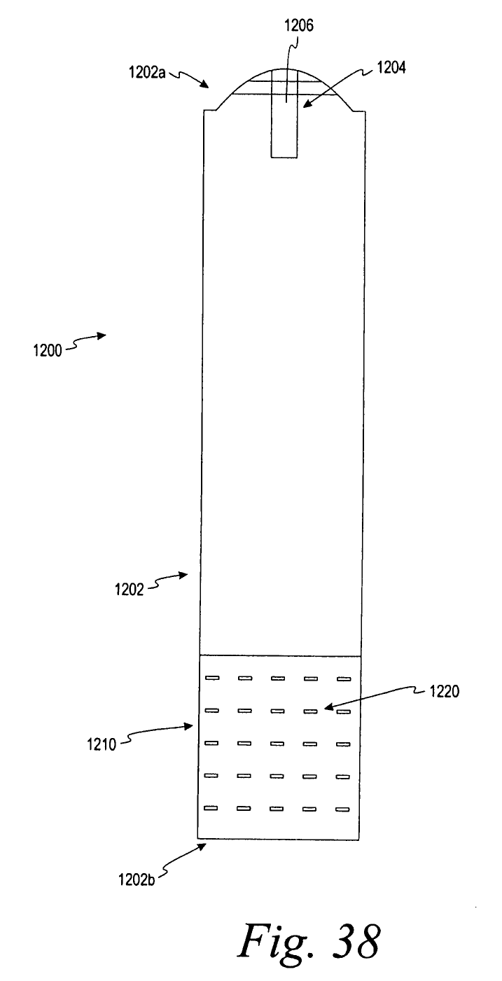

Referring to FIG. 38, an optical test sensor 1200 is shown according to one embodiment. The optical test sensor includes a base 1202 and a fluid-receiving area 1204 that includes at least one reagent 1206. The base 1202 includes a first end 1202a and an opposing second end 1202b. The fluid-receiving area 1204 is positioned at or near the first end 1202a. The optical test sensor 1200 includes a non-conductive, auto-calibration area 1210. Specifically, the auto-calibration area 1210 includes non-conductive markings 1220 that correspond to the auto-calibration information. The markings 1220 are similar to the markings 1020 described above. The markings 1220 are in a pattern and correspond to auto-calibration information that is adapted to be optically detected. The markings 1220 may also include the constant markings and variable markings discussed above in FIGS. 34-36.

The auto-calibration area 1220 is shown in FIG. 38 as being on the base on the same side as the fluid-receiving area. It is contemplated that the auto-calibration area may be formed on an opposing surface as the fluid-receiving area.

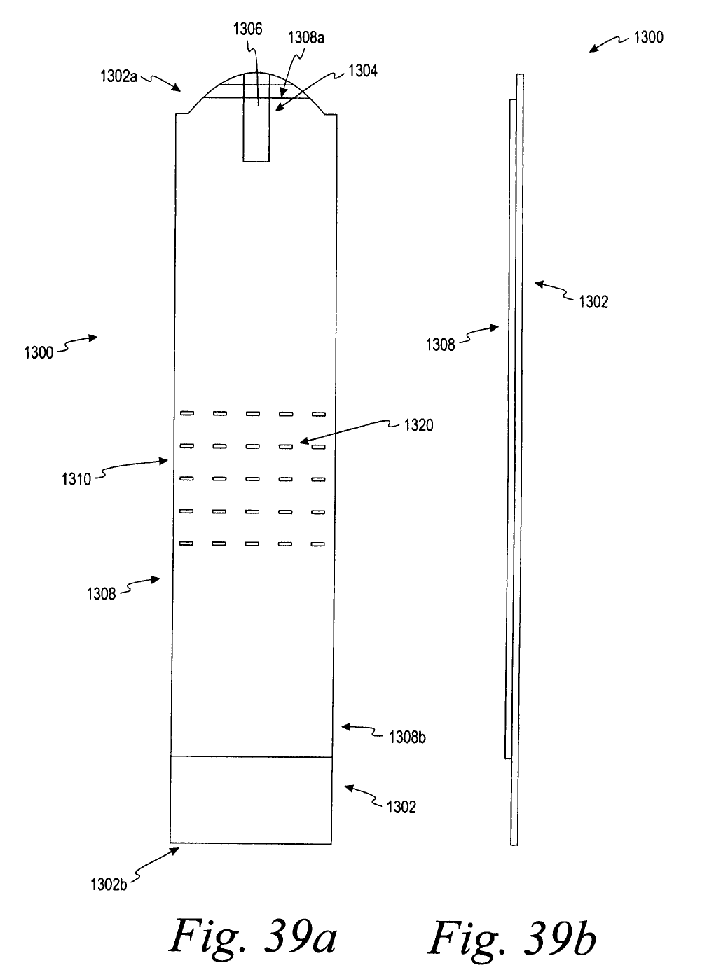

In another embodiment, an optical sensor 1300 of FIG. 39 includes a base 1302, a fluid-receiving area 1304 that includes at least one reagent 1306 and a lid 1308. The base 1302 includes a first base end 1302a and an opposing second base end 1302b. The fluid-receiving area 1304 is positioned at or near the first end 1302a.

The lid 1308 includes a first end 1308a and an opposing second end 1308b. The lid includes a non-conductive, auto-calibration area 1310. Specifically, the auto-calibration area 1310 includes a plurality of non-conductive markings 1320 corresponding to auto-calibration information. The markings 1320 are similar to the markings 1020 described above in FIGS. 33, 34. The markings 1320 are in a pattern and correspond to auto-calibration information that is adapted to be optically detected. In this embodiment, the auto-calibration markings are located in the general middle area of the test sensor. It is contemplated that the auto-calibration area on the lid may be located in different areas. For example, the auto-calibration markings may be located at or near the opposing second end 1308b.

### Process A

A method of making a test sensor adapted to assist in determining the concentration of an analyte in a fluid sample, the method comprising the acts of: providing a lid;

providing a base;

attaching the lid to the base to form an attached lid-base structure, the lid-base structure having a first end adapted to receive the fluid sample and a second opposing end adapted to be placed into a meter;

assigning auto-calibration information to the lid-base structure; and

forming the second opposing end such that the shape of the second opposing end corresponds to the auto-calibration information.

### Process B

The method of process A wherein the forming of the second opposing end is done by cutting to a desired shape.

### Process C

The method of process A wherein the forming of the second opposing end is done by punching to a desired shape.

### Process D

The method of process A wherein the test sensor further includes a spacer, the spacer being located between the lid and the base.

### Process E

The method of process A wherein the auto-calibration information is a program auto-calibration number.

### Process F

The method of process A wherein the test sensor is an optical test sensor.

### Process G

The method of process A wherein the test sensor is an electrochemical test sensor.

### Process H

A method of using a test sensor and a meter, the test sensor and meter being adapted to use auto-calibration information in determining the concentration of an analyte in a fluid sample, the method comprising the acts of:

providing a test sensor including a lid portion and a base portion, the lid and the base portions forming a lid-base structure, the lid-base structure having a first end adapted to receive the fluid sample and a second opposing end adapted to be placed into a meter;

assigning auto-calibration information to the lid-base structure;

forming the second opposing end such that the shape of the second opposing end corresponds to the auto-calibration information;

providing a meter with a test-sensor opening;

placing the second opposing end of the test sensor into the test-sensor opening of the meter;

detecting the shape of the second opposing end; and

applying the auto-calibration information determined from the shape of the second opposing end to assist in determining the analyte concentration.

### Process I

The method of process H wherein the detecting the shape of the second opposing end is performed using an optical read head.

### Process J

The method of process H further comprising determining the analyte concentration of the sample using the test sensor and the fluid sample.

### Process K

The method of process J wherein the fluid sample is blood.

### Process L

The method of process J wherein the analyte is glucose.

### Process M

The method of process H wherein the placing of the second opposing end of the test sensor into the test-sensor opening is done manually.

### Process N

The method of process H wherein the placing of the second opposing end of the test sensor into the test-sensor opening is done automatically.

### Process O

The method of process H wherein the lid portion and the base portion form as integrated lid-base structure.

### Process P

The method of process H wherein the lid portion and the base portion are attached to form the lid-base structure.

### Process Q

The method of process H wherein the forming of the second opposing end is done by cutting to a desired shape.

### Process R

The method of process H wherein the forming of the second opposing end is done by punching to a desired shape.

### Process S

The method of process H wherein the test sensor further includes a spacer, the spacer being located between the lid and the base.

### Process T

The method of process H wherein the auto-calibration information is a program auto-calibration number.

### Process U

The method of process H wherein the test sensor is an optical test sensor.

### Process V

The method of process H wherein the test sensor is an electrochemical test sensor.

### Process W

A method of making a test sensor adapted to assist in determining the concentration of an analyte in a fluid sample, the method comprising the acts of:

providing a lid;

providing a base;

attaching the lid to the base to form an attached lid-base structure, the lid-base structure having a first end adapted to receive the fluid sample and a second opposing end adapted to be placed into a meter;

assigning auto-calibration information to the lid-base structure; and

forming at least one cutout near or at the second opposing end such that the shape, dimensions and/or number of the at least one cutout corresponds to the program auto-calibration number.

### Process X

The method of process W wherein the at least one cutout is exactly one cutout.

### Process Y

The method of process W wherein the at least one cutout is a plurality of cutouts.

### Process Z

The method of process W wherein the at least one cutout extends through the lid-base structure.

### Process AA

The method of process W wherein the forming of the at least one cutout is done by cutting to a desired shape.

### Process BB

The method of process W wherein the forming of the at least one cutout is done by punching to a desired shape.

### Process CC

The method of process W wherein the test sensor further includes a spacer, the spacer being located between the lid and the base.

### Process DD

The method of process W wherein the auto-calibration information is a program auto-calibration number.

### Process EE

The method of process W wherein the test sensor is an optical test sensor.

### Process FF

The method of process W wherein the test sensor is an electrochemical test sensor.

### Process GG

A method of using a test sensor and a meter, the test sensor and meter being adapted to use auto-calibration information in determining the concentration of an analyte in a fluid sample, the method comprising the acts of:

providing a test sensor including a lid portion and a base portion, the lid and the base portions forming a lid-base structure, the lid-base structure having a first end adapted to receive the fluid sample and a second opposing end adapted to be placed into a meter;

assigning auto-calibration information to the lid-base structure;

forming at least one cutout near or at the second opposing end such that the shape, dimensions and/or number of the at least one cutout corresponds to the program auto-calibration number;

providing a meter with a test-sensor opening;

placing the second opposing end of the test sensor into the test-sensor opening of the meter;

detecting the shape, dimensions and/or number of the at least one cutout of the second opposing end; and

applying the auto-calibration information determined from the shape of the cutout to assist in determining the analyte concentration.

### Process HH

The method of process GG wherein the detecting the shape, dimensions and/or number of the at least one cutout is performed using an optical read head.

### Process II

The method of process GG further comprising determining the analyte concentration of the sample using the test sensor and the fluid sample.

### Process JJ

The method of process II wherein the fluid sample is blood.

### Process KK

The method of process II wherein the analyte is glucose.

### Process LL

The method of process GG wherein the placing of the second opposing end of the test sensor into the test-sensor opening is done manually.

### Process MM

The method of process GG wherein the placing of the second opposing end of the test sensor into the test-sensor opening is done automatically.

### Process NN

The method of process GG wherein the lid portion and the base portion form an integrated lid-base structure.

### Process OO

The method of process GG wherein the lid portion and the base portion are attached to form the lid-base structure.

### Process PP

The method of process GG wherein the forming of the at least one cutout is done by cutting to a desired shape.

### Process QQ

The method of process GG wherein the forming of the at least one cutout is done by punching to a desired shape.

### Process RR

The method of process GG wherein the test sensor further includes a spacer, the spacer being located between the lid and the base.

### Process SS

The method of process GG wherein the auto-calibration information is a program auto-calibration number.

### Process TT

The method of process GG wherein the test sensor is an optical test sensor.

### Process UU

The method of process GG wherein the test sensor is an electrochemical test sensor.

### Process VV

A method of making a test sensor adapted to assist in determining the concentration of an analyte in a fluid sample, the method comprising the acts of:

providing a lid;

providing a base;

attaching the lid to the base to form an attached lid-base structure, the lid-base structure having a first end adapted to receive the fluid sample and a second opposing end adapted to be placed into a meter;

assigning auto-calibration information to the lid-base structure; and

forming at least one partial cutout near or at the second opposing end such that the shape, dimensions and/or number of the at least one partial cutout corresponds to the program auto-calibration number.

### Process WW

The method of process VV wherein the at least one partial cutout is exactly one partial cutout.

### Process XX

The method of process VV wherein the at least one partial cutout extends through the lid-base structure.

### Process YY

The method of process VV wherein the forming of the at least one partial cutout is done by cutting to a desired shape.

### Process ZZ

The method of process VV wherein the test sensor further includes a spacer, the spacer being located between the lid and the base.

### Process AAA

The method of process VV wherein the auto-calibration information is a program auto-calibration number.

### Process BBB

The method of process VV wherein the test sensor is an optical test sensor.

### Process CCC

The method of process VV wherein the test sensor is an electrochemical test sensor.

### Process DDD

A method of using a test sensor and a meter, the test sensor and meter being adapted to apply auto-calibration information in determining the concentration of an analyte in a fluid sample, the method comprising the acts of:

providing a test sensor including a lid portion and a base portion, the lid and the base portions forming a lid-base structure, the lid-base structure having a first end adapted to receive the fluid sample and a second opposing end adapted to be placed into a meter;

assigning auto-calibration information to the lid-base structure;

forming at least one partial cutout near or at the second opposing end such that the shape, dimensions and/or number of the at least one partial cutout corresponds to the program auto-calibration number;

providing a meter with a test-sensor opening;

placing the second opposing end of the test sensor into the test-sensor opening of the meter;

detecting the shape, dimensions and/or number of the at least one partial cutout of the second opposing end; and

applying the auto-calibration information determined from the shape of the partial cutout to assist in determining the analyte concentration.

### Process EEE

The method of process DDD wherein the detecting the shape, dimensions and/or number of the at least one partial cutout is performed using an optical read head.

### Process FFF

The method of process DDD further comprising determining the analyte concentration of the sample using the test sensor and the fluid sample.

### Process GGG

The method of process FFF wherein the fluid sample is blood.

### Process HHH

The method of process FFF wherein the analyte is glucose.

### Process III

The method of process DDD wherein the placing of the second opposing end of the test sensor into the test-sensor opening is done manually.

### Process JJJ

The method of process DDD wherein the placing of the second opposing end of the test sensor into the test-sensor opening is done automatically.

### Process KKK

The method of process DDD wherein the lid portion and the base portion form an integrated lid-base structure.

### Process LLL

The method of process DDD wherein the lid portion and the base portion are attached to form the lid-base structure.

### Process MMM

The method of process DDD wherein the forming of the at least one partial cutout is done by cutting to a desired shape.

### Process NNN

The method of process DDD wherein the at least one partial cutout extends through the lid-base structure.

### Process OOO

The method of process DDD wherein the test sensor further includes a spacer, the spacer being located between the lid and the base.

### Process PPP

The method of process DDD wherein the auto-calibration information is a program auto-calibration number.

### Process QQQ

The method of process DDD wherein the test sensor is an optical test sensor.

### Process RRR

The method of process DDD wherein the test sensor is an electrochemical test sensor.

### Process SSS

A method of making a test sensor adapted to assist in determining the concentration of an analyte in a fluid sample, the method comprising the acts of:

providing a base with a first end adapted to receive the fluid sample and a second opposing end adapted to be placed into a meter;

assigning auto-calibration information to the base; and

forming the second opposing end of the base such that the shape of the second opposing end corresponds to the auto-calibration information.

### Process TTT

A method of using a test sensor and a meter, the test sensor and meter being adapted to use auto-calibration information in determining the concentration of an analyte in a fluid sample, the method comprising the acts of:

providing a test sensor including a base with a first end adapted to receive the fluid sample and a second opposing end adapted to be placed into a meter;

assigning auto-calibration information to the test sensor;

forming the second opposing end such that the shape of the second opposing end corresponds to the auto-calibration information;

providing a meter with a test-sensor opening;

placing the second opposing end of the test sensor into the test-sensor opening of the meter;

detecting the shape of the second opposing end; and

applying the auto-calibration information determined from the shape of the second opposing end to assist in determining the analyte concentration.

### Process UUU

A method of making a test sensor adapted to assist in determining the concentration of an analyte in a fluid sample, the method comprising the acts of:

providing a base with a first end adapted to receive the fluid sample and a second opposing end adapted to be placed into a meter;

assigning auto-calibration information to the base; and

forming at least one cutout near or at the second opposing end such that the shape, dimensions and/or number of the at least one cutout corresponds to the program auto-calibration number.

### Process VVV

A method of using a test sensor and a meter, the test sensor and meter being adapted to use auto-calibration information in determining the concentration of an analyte in a fluid sample, the method comprising the acts of:

providing a base with a first end adapted to receive the fluid sample and a second opposing end adapted to be placed into a meter;

assigning auto-calibration information to the test sensor;

forming at least one cutout near or at the second opposing end such that the shape, dimensions and/or number of the at least one cutout corresponds to the program auto-calibration number.

providing a meter with a test-sensor opening;

placing the second opposing end of the test sensor into the test-sensor opening of the meter;

detecting the shape, dimensions and/or number of the at least one cutout of the second opposing end; and

applying the auto-calibration information determined from the shape of the cutout to assist in determining the analyte concentration.

### Process WWW

A method of making a test sensor adapted to assist in determining the concentration of an analyte in a fluid sample, the method comprising the acts of:

providing a base with a first end adapted to receive the fluid sample and a second opposing end adapted to be placed into a meter;

assigning auto-calibration information to the base; and

forming at least one partial cutout near or at the second opposing end such that the shape, dimensions and/or number of the at least one partial cutout corresponds to the program auto-calibration number.

### Process XXX

A method of using a test sensor and a meter, the test sensor and meter being adapted to apply auto-calibration information in determining the concentration of an analyte in a fluid sample, the method comprising the acts of:

providing a base with a first end adapted to receive the fluid sample and a second opposing end adapted to be placed into a meter;

assigning auto-calibration information to the test sensor;

forming at least one partial cutout near or at the second opposing end such that the shape, dimensions and/or number of the at least one partial cutout corresponds to the program auto-calibration number.

providing a meter with a test-sensor opening;

placing the second opposing end of the test sensor into the test-sensor opening of the meter;

detecting the shape, dimensions and/or number of the at least one partial cutout of the second opposing end; and

applying the auto-calibration information determined from the shape of the partial cutout to assist in determining the analyte concentration.

### Embodiment YYY

An electrochemical test sensor being adapted to determine an analyte concentration of a fluid sample, the electrochemical test sensor comprising:

a base including a first base end and an opposing second base end;

a plurality of electrodes being formed on the base at or near the first end, the plurality of electrodes including a working electrode and a counter electrode; and

at least one reagent being positioned at or near the first end so as to contact the fluid sample,

wherein the electrochemical test sensor includes a first end and an opposing second end, the test sensor having an auto-calibration area, the auto-calibration area having non-conductive markings in a form of a pattern corresponding to auto-calibration information, the markings being adapted to be optically detected.

### Embodiment ZZZ

The test sensor of embodiment YYY wherein the auto-calibration area is of a generally uniform color and the markings are of a contrasting color or shade.

### Embodiment A4

The test sensor of embodiment YYY wherein the auto-calibration area is formed on the base at the opposing second base end.

### Embodiment B4

The test sensor of embodiment YYY further including a lid, the lid covering at least a portion of the base, the lid having a first lid end and an opposing second lid end.

### Embodiment C4

The test sensor of embodiment B4 wherein the auto-calibration area is formed on the lid.

### Embodiment D4

The test sensor of embodiment C4 wherein the auto-calibration area is formed on the opposing second lid end.

### Embodiment E4

The test sensor of embodiment YYY wherein the markings including constant markings and variable markings.

### Embodiment F4

An optical test sensor being adapted to determine an analyte concentration of a fluid sample, the optical test sensor comprising:

a base including a first base end and an opposing second base end;

a fluid receiving area being adapted to receive a fluid sample, the fluid-receiving area being located near or at the first base end;

at least one reagent being positioned to contact the fluid sample in the fluid-receiving area, the at least one reagent assisting in optically determining the analyte concentration of the fluid sample;

wherein the optical test sensor includes a first end and an opposing second end, the test sensor having an auto-calibration area, the auto-calibration area having non-conductive markings in a form of a pattern corresponding to auto-calibration information, the markings being adapted to be optically detected.

### Embodiment G4

The test sensor of embodiment F4 wherein the auto-calibration area is of a generally uniform color and the markings are of a contrasting color or shade.

### Embodiment H4

The test sensor of embodiment F4 wherein the auto-calibration area is formed on the base at the opposing second base end.

### Embodiment I4

The test sensor of embodiment F4 further including a lid, the lid covering at least a portion of the base, the lid having a first lid end and an opposing second lid end.

### Embodiment J4

The test sensor of embodiment I4 wherein the auto-calibration area is formed on the lid.

### Embodiment K4

The test sensor of embodiment J4 wherein the auto-calibration area is formed on the opposing second lid end.

### Embodiment L4

The test sensor of embodiment F4 wherein the markings including constant markings and variable markings.

While the present invention has been described with reference to one or more particular embodiments, those skilled in the art will recognize that many changes may be made thereto without departing from the spirit and scope of the present invention. Each of these embodiments, and obvious variations thereof, is contemplated as falling within the spirit and scope of the invention as defined by the appended claims.

1. A method of making a test sensor adapted to assist in determining the concentration of an analyte in a fluid sample, the method comprising the acts of:
providing a lid;
providing a base;
attaching the lid to the base to form an attached lid-base structure, the lid-base structure having a first end adapted to receive the fluid sample and a second opposing end adapted to be placed into a meter;
assigning auto-calibration information to the lid-base structure; and
forming the second opposing end such that the shape of the second opposing end corresponds to the auto-calibration information.

2. The method of claim 1, wherein the test sensor further includes a spacer, the spacer being located between the lid and the base.

3. The method of claim 1, wherein the auto-calibration information is a program auto-calibration number.

4. The method of claim 1, wherein the test sensor is an optical test sensor.

5. The method of claim 1, wherein the test sensor is an electrochemical test sensor.

6. A method of making a test sensor adapted to assist in determining the concentration of an analyte in a fluid sample, the method comprising the acts of:
providing a lid;
providing a base;
attaching the lid to the base to form an attached lid-base structure, the lid-base structure having a first end adapted to receive the fluid sample and a second opposing end adapted to be placed into a meter;
assigning auto-calibration information to the lid-base structure; and
forming at least one cutout near or at the second opposing end such that the shape, dimensions and/or number of the at least one cutout corresponds to the program auto-calibration number.

7. The method of claim 6, wherein the at least one cutout is a plurality of cutouts.

8. The method of claim 6, wherein the test sensor further includes a spacer, the spacer being located between the lid and the base.

9. The method of claim 6, wherein the auto-calibration information is a program auto-calibration number.

10. A method of making a test sensor adapted to assist in determining the concentration of an analyte in a fluid sample, the method comprising the acts of:
providing a lid;
providing a base;
attaching the lid to the base to form an attached lid-base structure, the lid-base structure having a first end adapted to receive the fluid sample and a second opposing end adapted to be placed into a meter;
assigning auto-calibration information to the lid-base structure; and
forming at least one partial cutout near or at the second opposing end such that the shape, dimensions and/or number of the at least one partial cutout corresponds to the program auto-calibration number.

11. The method of claim 10, wherein the at least one partial cutout is exactly one partial cutout.

12. The method of claim 10, wherein the test sensor further includes a spacer, the spacer being located between the lid and the base.

13. The method of claim 10, wherein the auto-calibration information is a program auto-calibration number.

14. An electrochemical test sensor being adapted to determine an analyte concentration of a fluid sample, the electrochemical test sensor comprising:
a base including a first base end and an opposing second base end;
a plurality of electrodes being formed on the base at or near the first end, the plurality of electrodes including a working electrode and a counter electrode; and
at least one reagent being positioned at or near the first end so as to contact the fluid sample,
wherein the electrochemical test sensor includes a first end and an opposing second end, the test sensor having an auto-calibration area, the auto-calibration area having non-conductive markings in a form of a pattern corresponding to auto-calibration information, the markings being adapted to be optically detected.

15. The test sensor of claim 14, wherein the auto-calibration area is of a generally uniform color and the markings are of a contrasting color or shade.

16. The test sensor of claim 14, wherein the auto-calibration area is formed on the base at the opposing second base end.

17. The test sensor of claim 14, further including a lid, the lid covering at least a portion of the base, the lid having a first lid end and an opposing second lid end.

18. The test sensor of claim 17, wherein the auto-calibration area is formed on the lid.

19. The test sensor of claim 14, wherein the markings including constant markings and variable markings.

20. An optical test sensor being adapted to determine an analyte concentration of a fluid sample, the optical test sensor comprising:
a base including a first base end and an opposing second base end;
a fluid-receiving area being adapted to receive a fluid sample, the fluid-receiving area being located near or at the first base end;
at least one reagent being positioned to contact the fluid sample in the fluid-receiving area, the at least one reagent assisting in optically determining the analyte concentration of the fluid sample;
wherein the optical test sensor includes a first end and an opposing second end, the test sensor having an auto-calibration area, the auto-calibration area having non-conductive markings in a form of a pattern corresponding to auto-calibration information, the markings being adapted to be optically detected.

21. The test sensor of claim 20, wherein the auto-calibration area is of a generally uniform color and the markings are of a contrasting color or shade.

22. The test sensor of claim 20, wherein the auto-calibration area is formed on the base at the opposing second base end.

23. The test sensor of claim 20, further including a lid, the lid covering at least a portion of the base, the lid having a first lid end and an opposing second lid end.

24. The test sensor of claim 23, wherein the auto-calibration area is formed on the lid.

25. The test sensor of claim 20, wherein the markings including constant markings and variable markings.
